(19) United States
(12) Patent Application Publication
(10) Pub. No.: US 2006/0262007 A1
(43) Pub. Date: Nov. 23, 2006

(54) Methods and apparatus for automotive radar sensors

(75) Inventors: Andrew J. Bonthron, Los Angeles, CA (US); Gerald Juskovic, Newport Beach, CA (US)

Correspondence Address: IRELL & MANELLA LLP, 840 NEWPORT CENTER DRIVE, SUITE 400, NEWPORT BEACH, CA, 92660, US

(73) Assignee: Clariant Technologies, Corp.

(21) Appl. No.: 11/495,289

(22) Filed: Jul. 27, 2006

Related U.S. Application Data
(63) Continuation-in-part of application No. 11/036,318, filed on Jan. 14, 2005.
(60) Provisional application No. 60/703,150, filed on Jul. 27, 2005.
(60) Provisional application No. 60/537,287, filed on Jan. 16, 2004.

(51) Int. Cl. G01S 13/93

(52) U.S. Cl. 342/70; 342/107; 342/134; 342/137; 342/139; 342/196

(57) ABSTRACT

Methods and apparatus are presented that reduce the overall system cost for automotive radar sensing applications through reduction of the number of the radar sensors required. In accordance with aspects of the present invention, one way sensor count reduction can be achieved is through the combination of target range, direction, and velocity determination capability with wide angular field of view coverage within a single sensor unit. One embodiment combines a transmit-pulsed, linearly stepped frequency modulated, transmit power limited radar architecture with a spatially separated receiver antenna array, intermediate frequency down-conversion, and a digital multi-zone monopulse (DMM) signal processing technique for high-resolution target range, velocity, and azimuth angle determination and fast update rate capability in a low cost, mass-production-capable design.

### PRIORITY CLAIM

Priority is claimed to U.S. Provisional Application 60/703,150 filed Jul. 27, 2005. This is a continuation-in-part application of U.S. Ser. No. 11/036,318 filed Jan. 14, 2005, which claims priority to and incorporates by reference U.S. provisional application 60/537,287, filed Jan. 16, 2004.

### BACKGROUND OF THE INVENTION

1. Technical Field of the Invention

The subject matter disclosed generally relates to the field of automotive electronic systems and methods. More specifically, the subject matter disclosed relates to radar sensor arrangements that allow cost reduction and increased utility for automotive radar collision avoidance and driver aid applications.

2. Background of Related Art

To facilitate mass deployment of automotive radar sensors, reducing the total system cost per vehicle without compromising the capability, performance, or reliability of the system is desirable. Automotive short-range sensing applications typically aim to provide a complete or nearly complete surrounding coverage around a vehicle, with high-resolution target range, velocity, and angular resolution capability, and the ability to discriminate between multiple targets as required in near-distance driving scenarios. One way to reduce the system cost is to reduce the number of radar sensors necessary to provide the required coverage area and functionality for automotive collision avoidance and driving aid applications. One way this can be accomplished is through the creation of a compact radar sensor unit having a wide angular field of view coverage and containing target range, velocity, and direction-finding capability. By eliminating the need for multiple sensors having overlapping coverage area to determine a target field of view coverage and containing target range, velocity, and direction-finding capability. By eliminating the need for multiple sensors having overlapping coverage area to determine a target direction, and by having a wide angular field of view coverage sensor with direction-finding capability over the entire field of view, cost reduction can be achieved for the overall system. Furthermore, by increasing the ability to discriminate between multiple targets at the same range, a more practical near-distance driving solution can be provided.

Typical automotive short-range radar sensor systems comprise multiple discrete sensor units, each of which determines a target's range. A target's direction is typically determined through the comparison of the range measurements from a plurality of these sensor units, and calculated at the system level. A target's relative velocity is typically determined by positional variations overtime by the system, or through a separate CW Doppler radar mode once the target ranges are identified. Such systems may contain up to 16 sensors mounted around a car to achieve full-surround coverage area.

FIG. 1A illustrates one reduced sensor count configuration and angular detection regions that are possible for short-range radar applications by utilizing a radar architecture and method providing a wide angular field-of-view and high-resolution target range, velocity, and direction finding capability in a single sensor unit. In this arrangement, a vehicle 400 such as a car or truck uses four of such sensor units 420a, 420b, 420c, 420d to cover the front, rear, left and right side quadrants of the vehicle to provide a nearly complete surround coverage. Similarly, for vehicle applications requiring less than four-quadrant coverage, fewer sensors can be used, resulting in a lower system cost.

Ideally, it would be beneficial to monitor the region of an entire vehicle side using a wide angular field-of-view sensor to reduce cost. To do so, a very wide angular field-of-view is necessary, typically greater than or equal to 90 degrees. However, high range resolution capable short-range radar sensors transmit power is limited to a very low power spectral density due to the legislative requirements in the permissible spectral bands of operation, such as at or around an operation frequency of 24 GHz. Under such transmit power limited conditions, it is important for the radar sensor to contain transmit power limiting circuitry such that the output power does not exceed or fall much below the legislated requirement, since it is important to maximize SNR due to the very low allowed transmit power level. In addition, it becomes important to utilize receive antenna gain to maximize signal-to-noise-ratio (SNR). However, the wider the receive antenna beam-width, the lower the gain, which presents challenges for wide angular field-of-view applications. Furthermore, with a wide angular field-of-view it is especially important to have techniques for target angular resolution within that field-of-view for discriminating between multiple targets that occur in the same range bin. In addition, for many short-range applications, such as pre-crash detection, a fast update rate is important. However, having a fast update rate limits the integration or dwell time of the radar sensor, further limiting the SNR of detected targets.

Long-range radar sensors are typically placed in the front bumper of a vehicle. A typical automotive installation of a long-range radar sensor and corresponding angular detection region is shown in FIG. 1B. In this arrangement, a vehicle 400 such as a car or truck can utilize one such sensor unit 420e on the front of the vehicle to cover the forward-looking direction. Long-range radar sensors typically have a narrow field of view, typically 20 degrees or less, and are used for detecting targets at a much farther distance than short-range radar sensors. In addition, the typically permissible transmit powers are orders of magnitude higher than that for the typical transmit power-limited short-range radar sensors, and are typically higher than that obtainable by practical output amplifier integrated circuits or gains of transmit antennas of practical size. Due to this difference between long-range and short-range radar sensor allowed transmit power, long-range radars don't require output power-limiting circuitry such as that required for short-range radar sensors. Furthermore, the applications for long-range radar sensing typically require slower update rates than that for short-range pre-crash sensing applications, which can allow longer integration times and higher SNR. Typical automotive long-range radar applications are adaptive cruise control, roadside imaging, and road scenario analysis.

A further way to reduce cost is to reduce the number of separate integrated circuit chips that are required in the sensor. Typical time-domain, pseudo-noise coded radar sensors, such as pulse position modulation coded radars, require a correlation receiver architecture where the receiver and transmitter must operate simultaneously due to the length of the transmit pattern or code. In such sensors, transmitter and receiver isolation is important, and results in separate, physically separated transmit and receive chips, increasing cost.

### SUMMARY OF THE INVENTION

Methods and apparatus are presented that reduce the overall system cost for automotive radar sensing applications through reduction of the number of the radar sensors required. In accordance with aspects of the present invention, one way sensor count reduction can be achieved is through the combination of target range, direction, and velocity determination capability with wide angular field of view coverage within a single sensor unit. One embodiment combines a transmit-pulsed, linearly stepped frequency-modulated, transmit-power-limited radar architecture with a spatially separated receiver antenna array, intermediate frequency down-conversion, and a digital multi-zone monopulse (DMM) signal processing technique for high-resolution target range, velocity, and azimuth angle determination and fast update rate capability in a low cost, mass-production-capable design. Other methods and apparatus are presented.

### BRIEF DESCRIPTION OF THE DRAWINGS

The accompanying drawings are for the purpose of illustrating and expounding the features involved in the present invention for a more complete understanding, and not meant to be considered as a limitation, wherein:

FIG. 1A is a diagram illustrating a typical sensor arrangement for automotive sensor applications using radar sensors according to aspects of the present invention.

FIG. 1B is a diagram illustrating another typical sensor arrangement for automotive sensor applications using radar sensors according to aspects of the present invention.

FIG. 2A is a block diagram illustrating features of one embodiment of a radar sensor architecture according to aspects of the present invention.

FIG. 2B is a block diagram illustrating features of one embodiment of a radar sensor architecture according to aspects of the present invention.

FIG. 3A is a block diagram illustrating features of one embodiment of an antenna network according to aspects of the present invention.

FIG. 3B is a block diagram illustrating features of another embodiment of an antenna network according to aspects of the present invention.

FIG. 3C is a block diagram illustrating features of a further embodiment of an antenna network according to aspects of the present invention.

FIG. 3D is a block diagram illustrating features of a yet further embodiment of an antenna network according to aspects of the present invention.

FIG. 3E is a block diagram illustrating features of another embodiment of an antenna network according to aspects of the present invention.

FIG. 3F is a block diagram illustrating features of a further embodiment of an antenna network according to aspects of the present invention.

FIG. 4A is a diagram illustrating features of one embodiment of spatially separated antennas according to aspects of the present invention.

FIG. 4B is a diagram illustrating features of another embodiment of spatially separated antennas according to aspects of the present invention.

FIG. 5A is a diagram illustrating features of one embodiment of an antenna detection zone according to aspects of the present invention.

FIG. 5B is a diagram illustrating features of another embodiment of an antenna detection zone according to aspects of the present invention.

FIG. 5C is a diagram illustrating features of a further embodiment of an antenna detection zone according to aspects of the present invention.

FIG. 6A is a block diagram illustrating features of one embodiment of a transmit power limiting circuit according to aspects of the present invention.

FIG. 6B is a block diagram illustrating one example of a differential pair/current switch circuit according to aspects of the present invention.

FIG. 6C is a block diagram illustrating features of another embodiment of a transmit power limiting circuit according to aspects of the present invention.

FIG. 6D is a block diagram illustrating features of one embodiment of a dual-band transmit circuit according to aspects of the present invention.

FIG. 7 is a block diagram illustrating features of one embodiment of a radar sensor architecture according to aspects of the present invention.

FIG. 8A is a block diagram illustrating features of one embodiment of the Stepped Frequency Transmit Signal Generator 405 according to aspects of the present invention.

FIG. 8B is a block diagram illustrating features of another embodiment of the Stepped Frequency Transmit Signal Generator 405 according to aspects of the present invention.

FIG. 8C is a block diagram illustrating features of a further embodiment of the Stepped Frequency Transmit Signal Generator 405 according to aspects of the present invention.

FIG. 8D is a block diagram illustrating features of a yet further embodiment of the Stepped Frequency Transmit Signal Generator 405 according to aspects of the present invention.

FIG. 8E is a block diagram illustrating features of another embodiment of the Stepped Frequency Transmit Signal Generator 405 according to aspects of the present invention.

FIG. 8F is a block diagram illustrating features of a further embodiment of the Stepped Frequency Transmit Signal Generator 405 according to aspects of the present invention.

FIG. 8G is a block diagram illustrating features of a yet further embodiment of the Stepped Frequency Transmit Signal Generator 405 according to aspects of the present invention.

FIG. 9A illustrates an output waveform from the Stepped Frequency Transmit Signal Generator 405 in accordance with one embodiment of the present invention.

FIG. 9B illustrates an output waveform from the Stepped Frequency Transmit Signal Generator 405 in accordance with another embodiment of the present invention.

FIG. 9C illustrates an output waveform from the Frequency Stepped Frequency Transmit Signal Generator 405 in accordance with a further embodiment of the present invention.

FIG. 9D illustrates an output waveform from the Stepped Frequency Transmit Signal Generator 405 in accordance with a yet further embodiment of the present invention.

FIG. 9E illustrates an output waveform from the Stepped Frequency Transmit Signal Generator 405 in accordance with an alternate embodiment of the present invention.

FIG. 9F illustrates the output waveform from the Stepped Frequency Transmit Signal Generator 405 in accordance with another embodiment of the present invention.

FIG. 9G illustrates the output waveform from the Stepped Frequency Transmit Signal Generator 405 in accordance with a further embodiment of the present invention.

FIG. 9H illustrates the output waveform from the Stepped Frequency Transmit Signal Generator 405 in accordance with a yet further embodiment of the present invention.

FIG. 10A is a diagram illustrating receiver antenna selection timing according to aspects of the present invention.

FIG. 10B is a diagram illustrating A/D converter sample timing according to aspects of the present invention.

FIG. 10C is a diagram illustrating receiver antenna selection timing according to aspects of the present invention.

FIG. 10D is a diagram illustrating receiver antenna selection timing according to aspects of the present invention.

FIG. 10E is a diagram illustrating receiver antenna selection timing according to aspects of the present invention.

FIG. 10F is a diagram illustrating a method of creating digital target detection zones according to aspects of the present invention.

FIG. 10G is a diagram illustrating a method of phase-based direction finding according to aspects of the present invention.

FIG. 11 is an electrical block diagram illustrating features of another embodiment of a radar sensor architecture according to aspects of the present invention.

FIG. 12 is an electrical block diagram illustrating features of a further embodiment of a radar sensor architecture according to aspects of the present invention.

FIG. 13A is an electrical block diagram illustrating features of a yet further embodiment of a radar sensor architecture according to aspects of the present invention.

FIG. 13B is an electrical block diagram illustrating features of another embodiment of a radar sensor architecture according to aspects of the present invention.

FIG. 13C is an electrical block diagram illustrating features of a further embodiment of a radar sensor architecture according to aspects of the present invention.

FIG. 13D is an electrical block diagram illustrating features of a yet further embodiment of a radar sensor architecture according to aspects of the present invention.

FIG. 13E is an electrical block diagram illustrating features of another embodiment of a radar sensor architecture according to aspects of the present invention.

FIG. 13F is an electrical block diagram illustrating features of a further embodiment of a radar sensor architecture according to aspects of the present invention.

FIG. 13G is an electrical block diagram illustrating features of a yet further embodiment of a radar sensor architecture according to aspects of the present invention.

FIG. 13H is an electrical block diagram illustrating features of another embodiment of a radar sensor architecture according to aspects of the present invention.

FIG. 14A is an electrical block diagram illustrating features of another embodiment of a radar sensor architecture according to aspects of the present invention.

FIG. 14B is an electrical block diagram illustrating features of a further embodiment of a radar sensor architecture according to aspects of the present invention.

FIG. 14C is an electrical block diagram illustrating features of a yet further embodiment of a radar sensor architecture according to aspects of the present invention.

FIG. 15A is a diagram illustrating a transmit and receive antenna arrangement according to aspects of the present invention.

FIG. 15B is a diagram illustrating another transmit and receive antenna arrangement according to aspects of the present invention.

FIG. 15C is a diagram illustrating examples of receive antenna arrangements according to aspects of the present invention.

FIG. 16 is a diagram illustrating transmit and receive antenna selection timing according to aspects of the present invention.

FIG. 17A is a block diagram illustrating features of one embodiment of a radar sensor architecture according to aspects of the present invention.

FIG. 17B is a block diagram illustrating features of another embodiment of a radar sensor architecture according to aspects of the present invention.

FIG. 18A is a block diagram illustrating features of a further embodiment of a radar sensor architecture according to aspects of the present invention.

FIG. 18B is a block diagram illustrating features of one embodiment of Stepped PRI Modulation Transmit Signal Generator 408 according to aspects of the present invention.

FIG. 19 illustrates an output waveform from the Stepped PRI Modulation Signal Generator 235 in accordance with one embodiment of the present invention.

FIG. 20A is a block diagram illustrating features of one embodiment of a receiver configuration according to aspects of the present invention.

FIG. 20B is a block diagram illustrating features of another embodiment of a receiver configuration according to aspects of the present invention.

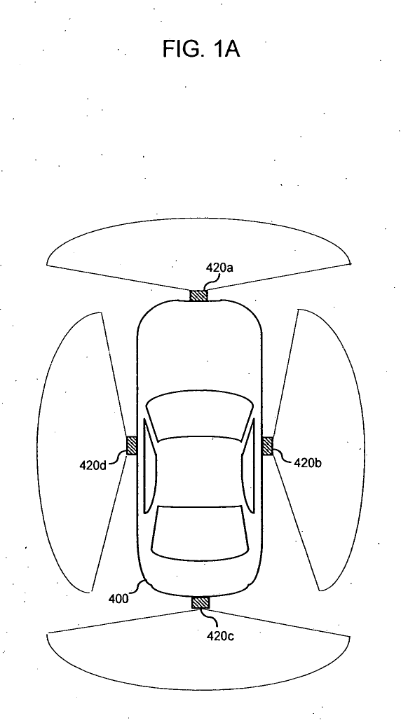

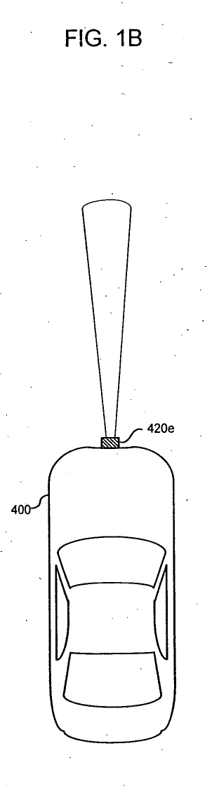

### DETAILED DESCRIPTION

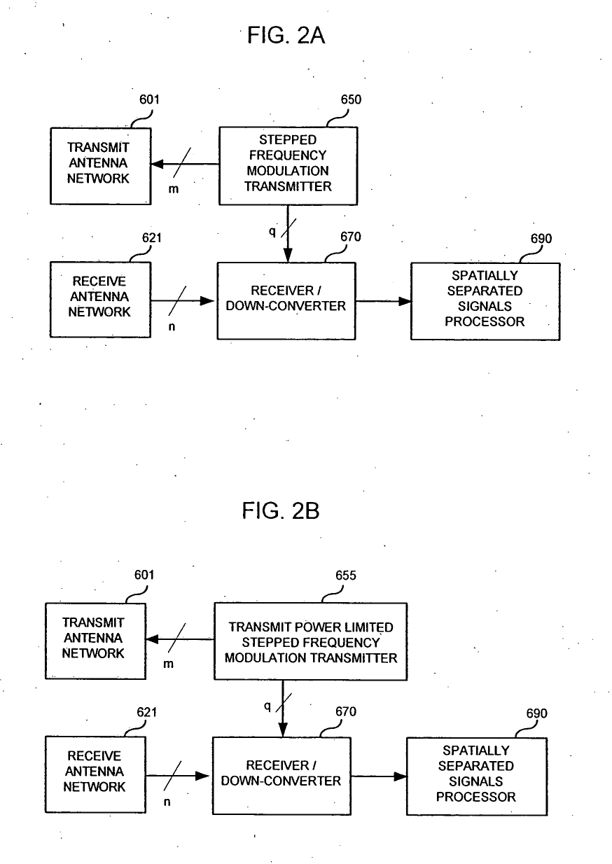

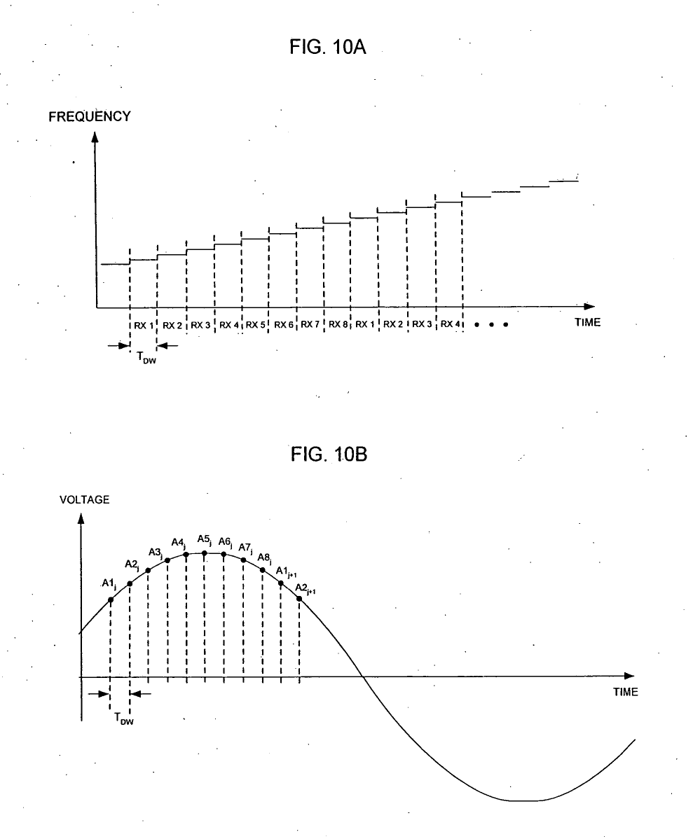

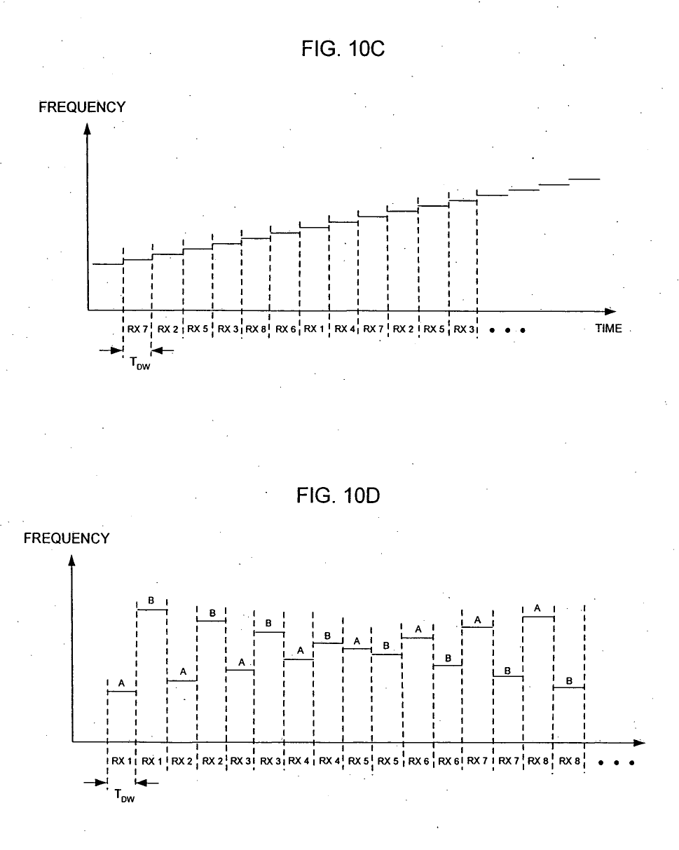

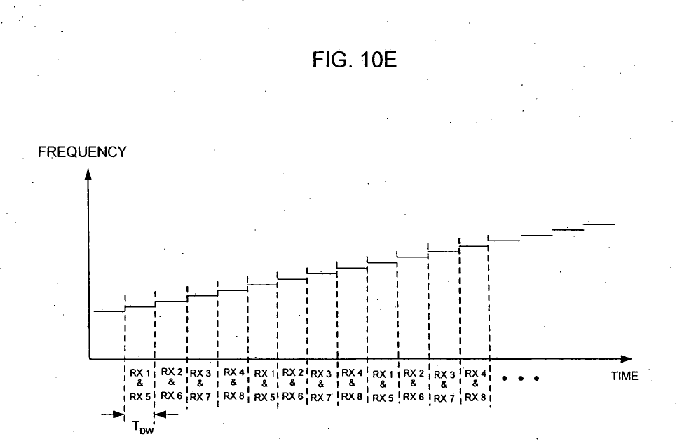

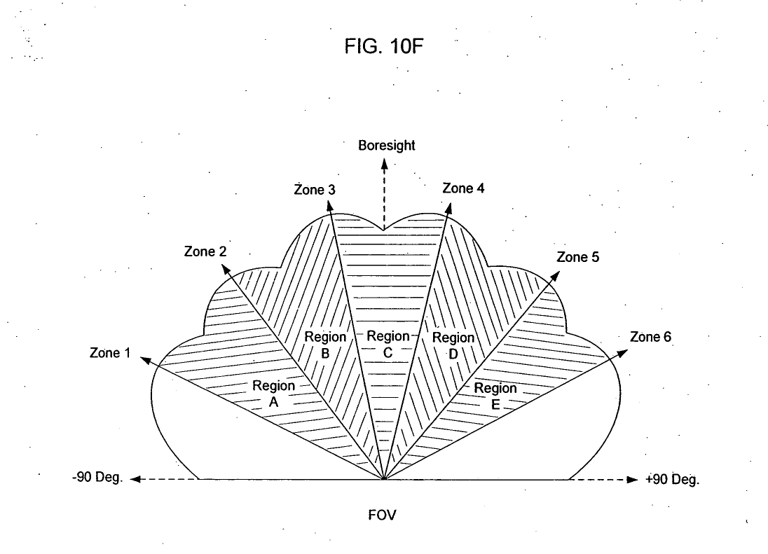

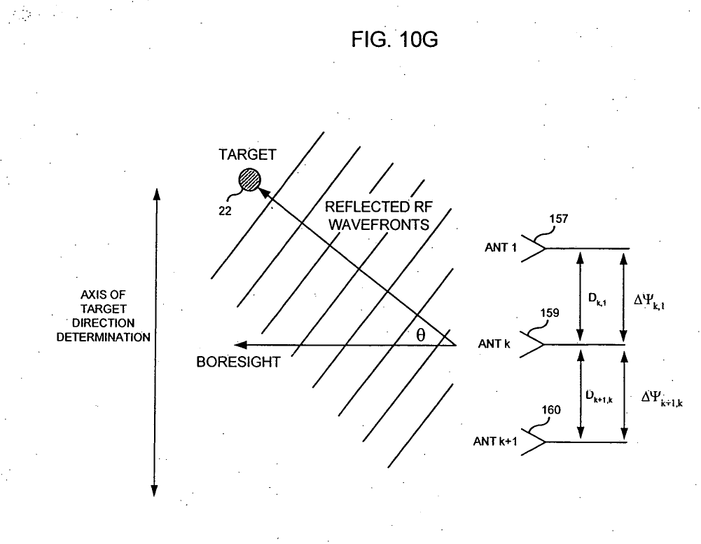

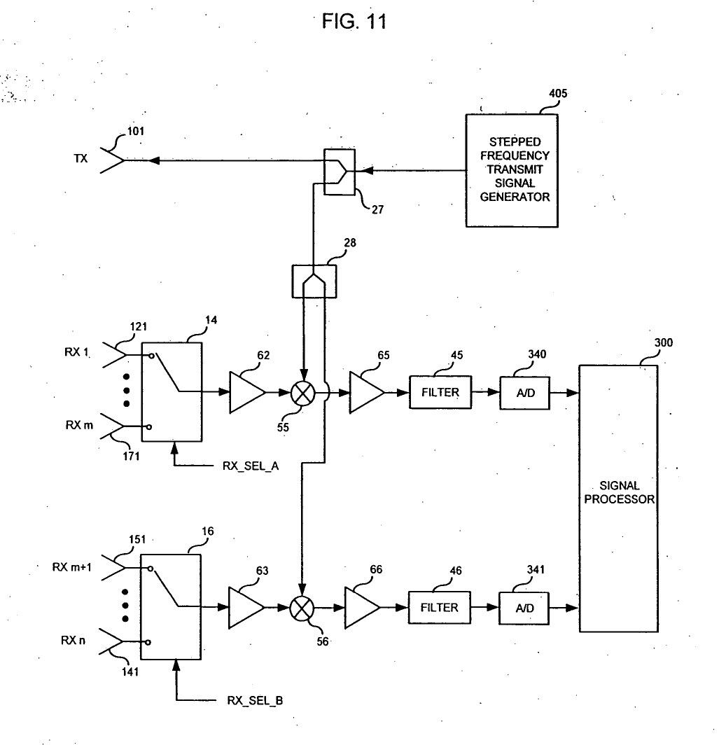

In the detailed descriptions and figures that follow, FIGS. 2A-B, 3A-F, 4A-B, 5A-C, 6A-D, 7, 8A-G, 9A-H, 11, 12, 13A-H, 14A-C, 15A-C, 16, 17A-B, 18A-B, 19, and 20A-B disclose stepped-frequency and/or stepped-PRI radar sensor architectures and methods for target range and/or velocity determination compatible with techniques of processing of spatially separated signals for target angular direction determination and/or multiple target angular discrimination, and FIGS. 10A-G illustrate examples of spatially separated signal processing techniques for target angular direction determination and/or multiple target angular discrimination. These figures and architectures are meant as examples, but not limitations, as additional methods can be used to create spatially separated signals compatible with the stepped waveforms and angular direction determination methods presented.

The spatially separated signals can be received using the different receiver methods described to provide multiple spatially separated received signals to a signal processor that utilizes spatially separated signal processing methods. These can further be combined with the stepped-waveform transmission, reception, and processing methods presented. Furthermore, through the utilization of antenna selection methods, multiple spatially separated signals can be received sequentially in time. Antenna selection methods enable a reduction of the number of required receiver channels, as a receiver channel is shared by a plurality of spatially separated signals in time sequence, for a more compact, less expensive solution. The potential cost of receiver channel reduction through antenna selection methods is a reduction in the signal-to-noise-ratio (SNR) of the received target signal for an equivalent update period, due to the reduction in dwell time per channel. Based on these principles, spatially separated signal implementations can be divided into three categories. The first category is Fully Sequential, whereby all spatially separated signals are received sequentially through a single receiver channel. The second category is Sequential-Parallel, whereby a plurality of parallel receive channels receive spatially separated signals sequentially. The third category is Fully Parallel, whereby each spatially separated signal has a corresponding receiver channel, and all receiver channels can operate simultaneously. For implementations that utilize one or more shared transmit/receive antennas, the above categorization applies as well. For transmit-power-limited implementations, both SNR and cost are important. Therefore, the Sequential-Parallel implementations provides both reduced cost and high SNR for transmit power limited sensors.

A radar sensor arrangement is presented in FIG. 2A as one embodiment of aspects of the present invention. In this arrangement, the Stepped Frequency Modulation Transmitter 650 outputs m signals to a Transmit Antenna Network 601 for electromagnetic emission, where m is an integer greater than or equal to 1. A typical frequency of the output signal emitted from the Transmit Antenna Network 601 can be within, but is not limited to, the frequency range of 22 GHz-29 GHz or 76 GHz-81 GHz. The radar sensor's total occupied transmit spectral bandwidth is dependent on the radar frequency modulation bandwidth, and can be ultra-wideband (UWB) to achieve increased range resolution for some automotive applications. The reflected signal from a target will be received by Receive Antenna Network 621, which will output n signals to a Receiver/Down-converter 670, where n is an integer greater than or equal to 1. The Receiver/Down-converter 670 also accepts q signals from the Stepped Frequency Modulation Transmitter 650, where q is an integer greater than or equal to 1, and outputs one or a plurality of down-converted difference signals each comprising at least one of the frequency or phase difference between components of the emitted signal and components of the corresponding received reflected signal from a target as an input to a Spatially Separated Signals Processor 690. The Spatially Separated Signals Processor 690 is used to determine at least the angular direction of one or a plurality of target returns based upon processing of the down-converted difference signals corresponding to a plurality of transmit and/or receive antenna locations which are spatially separated in the axis in which the angular direction of target returns is to be determined. The Receiver/Down-converter can utilize one or a plurality of individual down-conversion operations in generating the difference signals presented to the Spatially Separated Signals Processor. The Stepped Frequency Modulation Transmitter 650 can include, but is not limited to, generation of one or a plurality of linearly stepped frequency signals, intermediate frequency signal generation, local oscillator signal generation, transmit and/or receive gating signal generation, or transmit pulsing signal generation. The Transmit Antenna Network 601 can include, but is not limited to, a single antenna, a plurality of spatially separated antennas, or one or a plurality of groups of spatially separated antennas with one or a plurality of antennas simultaneously selected for emission of one or a plurality of signals. In addition, it may contain antenna elements for a purpose such as, but not limited to, the creation of multiple detection zones. The Receive Antenna Network 621 can include, but is not limited to, a single antenna, a plurality of spatially separated antennas, or one or a plurality of groups of spatially separated antennas with one or a plurality of antennas simultaneously selected for reception of one or a plurality of signals. In addition, it can contain antenna elements for a purpose such as, but not limited to, the creation of multiple detection zones. Furthermore, the transmit and receive antenna networks can be combined, such that one or more antennas can be time-shared for both transmitting and receiving functions.

A radar sensor arrangement is presented in FIG. 2B as another embodiment of aspects of the present invention. The arrangement in FIG. 2B is similar to the arrangement in FIG. 2A, except that the Stepped Frequency Modulation Transmitter 650 has been replaced by a Transmit-power-limited Stepped Frequency Modulation Transmitter 655. The same components are denoted by the same reference numerals, and will not be explained again. The Transmit-Power-limited Stepped Frequency Modulation Transmitter 655 is similar to the Stepped Frequency Modulation Transmitter 650 except for the addition of circuitry to limit and/or control the output transmit power. This circuitry is used in some short-range sensor frequency bands of operation where strict emission power limits are imposed with very low permissible transmit power density levels. Under these conditions, having power control circuitry that ensures the transmit power is close to, but below, the legislated limits allows legislative compliance and preserves signal to noise ratio, which is important for applications such as pre-crash detection.

Additionally, an architecture can combine a low transmit-power-limited operation, such as described in FIG. 2B, with a higher output power operation according to aspects of the present invention. For example, not meant in any way as a limitation, an architecture can utilize switching between different frequency/legislative bands of operation, where one band of operation requires a low transmit-power-limited operation. One example, not meant in any way as a limitation, can be for the radar sensor to switch between operation in the ISM frequency band of operation where a higher transmit power is allowed but a narrower bandwidth of operation is legislatively allocated, resulting in greater operating range but poorer range resolution, and a low transmit-power-limited band of operation where transmit power is limited to a lower value but the legislatively permitted operating bandwidth is much larger, resulting in a better range resolution for shorter range operation. One example of a frequency band of operation within an ISM band, not meant as a limitation, is from 24.05 GHz to 24.15 GHz. One example of a frequency band of operation within a low transmit-power-limited band, not meant as a limitation, is from 24.3 GHz to 25.5 GHz. Furthermore, the low transmit-power-limited band may overlap the ISM band, but may be required to preclude simultaneous operation for compliance. Because of the different permissible transmit power spectral densities and the difference of operation between the different bands, a common amplifier and transmission antenna will generally not be used for both bands. The transmitted signals for each band of operation may be transmitted in the same or different detection zones. In addition, one band or configuration of operation may be used to activate another band or configuration of operation. For example, not in any way meant as a limitation, an ISM band of operation may be used to detect a target situation that will then activate switching to another band of operation, such as a higher bandwidth, higher range resolution operation when the target is sufficiently close to be accurately detected through transmit power limited operation. Other criteria may be used to determine when to switch bands of operation, such as, but not limited to, duration of time in a band of operation or operational mode of a vehicle, such as, but not limited to, backup or lo parking, or due to vehicle speed. Another advantage of dual-band operation is to reduce the average level of interference introduced by transmit-power-limited operation to licensed bands sharing the same spectrum.

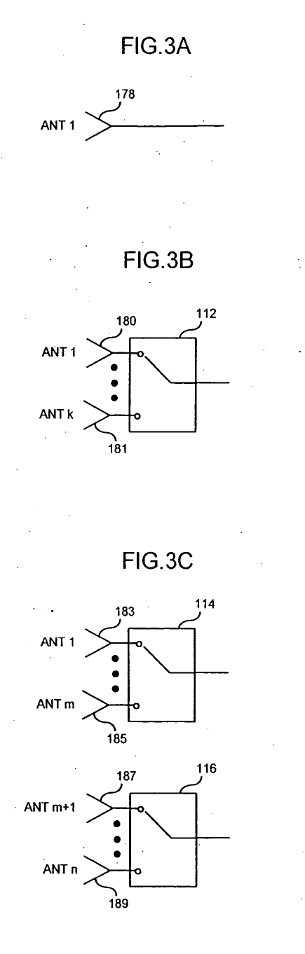

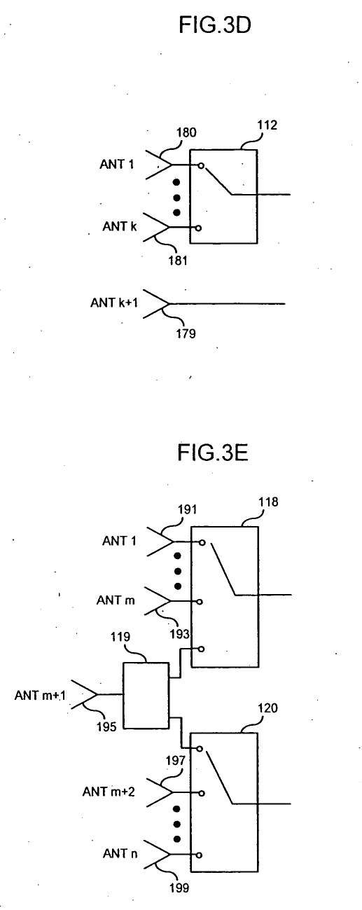

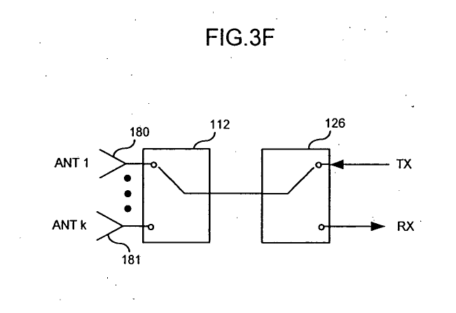

An antenna arrangement is illustrated in FIG. 3A as one embodiment of Transmit Antenna Network 601 and as one embodiment of Receive Antenna Network 621 according to aspects of the present invention. In this arrangement, a separate antenna 178 is connected to each of m transmit signals and/or each of n receive signals as defined in FIGS. 2A-B. The antennas can each have similar characteristics to one another, or can have different characteristics from one another depending on the requirements of the application.

An antenna arrangement is illustrated in FIG. 3B as another embodiment of Transmit Antenna Network 601 and as another embodiment of Receive Antenna Network 621 according to aspects of the present invention. In this arrangement, a selector 112 selectively establishes a connection between each of k antennas 180, 181 and a common input or output connection depending on whether the selector is used for transmit or receive application respectively. A selector 112 can be used with each or any of the m transmit signals and/or n receive signals as defined in FIGS. 2A-B. Selector 112 can be implemented by, but is not limited to, a switch or a combination of switches, or a combination of switched amplifiers and signal combiners/splitters wherein switching the gain/loss of said amplifiers is used for the selection function and said signal combiners/splitters can be implemented by, but are not limited to, Wilkinson combiners/splitters. One advantage of using switched amplifiers and signal combiners/splitters as a selection means is the elimination of the signal loss associated with series selection switches. The antennas can each have similar characteristics to one another, or can have different characteristics from one another depending on the requirements of the application.

An antenna arrangement is illustrated in FIG. 3C as a further embodiment of Transmit Antenna Network 601 and as a further embodiment of Receive Antenna Network 621 according to aspects of the present invention. In this arrangement, a plurality of selectors 114, 116 are used to select between antennas in a plurality of antenna groups. In FIG. 3C, m is an integer greater than or equal to 2, and n is an integer greater than or equal to 4. Selector 114 selectively establishes a connection between each of the plurality of antennas 183, 185 in one antenna group and a common input or output connection depending on whether the selector is used to transmit or receive, respectively. Similarly, selector 116 selectively establishes a connection between each of the plurality of antennas 187, 189 in another antenna group and a common input or output connection depending on whether the selector is used for transmit or receive application respectively. Selectors 114, 116 can be used with each or any of the transmit signals and/or receive signals as defined in FIGS. 2A-B. Selectors 114, 116 can be implemented by, but are not limited to, switches or a combination of switches, or combinations of switched amplifiers and signal combiners/splitters. The antennas can each have similar characteristics to one another, or can have different characteristics from one another depending on the requirements of the application. As compared with the configuration shown in FIG. 3B, the configuration shown in FIG. 3C requires fewer switching steps to sequence through a set of k antennas, where k=n, resulting in longer dwell times for each selected antenna, resulting in higher SNR. This increased SNR is especially important for low transmit-power-limited sensors.

An antenna arrangement is illustrated in FIG. 3D as a yet further embodiment of Transmit Antenna Network 601 and as a yet further embodiment of Receive Antenna Network 621 according to aspects of the present invention. In this arrangement, a selector 112 selectively establishes a connection between each of k antennas 180, 181 and a common input or output connection depending on whether the selector is used for transmit or receive application respectively. In FIG. 3D, k is an integer greater than or equal to 2. In parallel, an antenna 179 has a fixed connection with an input or output connection depending on whether the selector is used to transmit or receive, respectively. Selector 112 can be implemented by, but is not limited to, a switch or a combination of switches, or a combination of switched amplifiers and signal combiners/splitters. This arrangement is used to illustrate that antenna selectors can be used in conjunction with fixed antenna connections to suit the requirements of a particular application.

An antenna arrangement is illustrated in FIG. 3E as another embodiment of Transmit Antenna Network 601 and as another embodiment of Receive Antenna Network 621 according to aspects of the present invention. In this arrangement, a plurality of selectors 118, 120 are used to select between antennas in a plurality of antenna groups, but share one or more common antennas between them. In FIG. 3E, m is an integer greater than or equal to 2, and n is an integer greater than or equal to 5. Selector 118 selectively establishes a connection between each of the plurality of antennas 191, 193, 195 and a common input or output connection depending on whether the selector is used to transmit or receive, respectively. Similarly, selector 120 selectively establishes a connection between each of the plurality of antennas 195, 197, 199 and a common input or output connection depending on whether the selector is used to transmit or receive, respectively. Signal distributor 119 allows antenna 195 to share its connection with both selectors 118, 120. Signal distributor 119 can be implemented by, but is not limited to, a signal splitter, a signal combiner, or a switch. Selectors 118, 120 can be implemented by, but are not limited to, switches or a combination of switches, or combinations of switched amplifiers and signal combiners/splitters. Selectors 118, 120 can be used with each or any of the transmit signals and/or receive signals as defined in FIGS. 2A-B. Selectors 118, 120 can be used for transmit antenna selection, receive antenna selection, or to switch common elements between transmit and receive functions. The antennas can each have similar characteristics to one another, or can have different characteristics from one another depending on the requirements of the application. This arrangement is used to illustrate that antenna selectors can share common antennas between them, and that common antennas can be shared between transmit and receive functions.

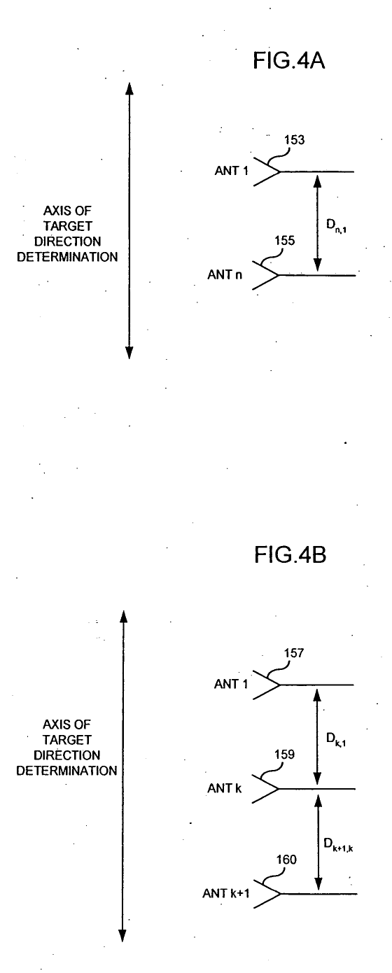

An antenna arrangement is illustrated in FIG. 3F as a further embodiment of Transmit Antenna Network 601 and Receive Antenna Network 621 according to aspects of the present invention. In this arrangement, a selector 112 selectively establishes a connection between each of k antennas 180, 181 with the common port of a selector 126. In FIG. 3F, k is an integer greater than or equal to 2. The selector 126 selectively establishes a connection between its common port, which can be connected with any of the k antennas by selector 112, and either the transmit or receive signals as defined in FIGS. 2A-B. In this way, the k antennas 180, 181 can be shared between transmit and receive functions. Selectors 112, 126 can be implemented by, but are not limited to, switches or a combination of switches, or combinations of switched amplifiers and signal combiners/splitters. The antennas can each have similar characteristics to one another, or can have different characteristics from one another depending on the requirements of the application. One example of antenna spatial separation is illustrated in FIG. 4A according to aspects of the present invention. The example of antenna spatial separation shown in FIG. 4A is for illustration purposes and is not considered a limitation. In this arrangement, n antennas 153, 155 are separated from one another by a distance D_{n,1} in the axis of target direction determination. For antennas that are not aligned in the axis of direction determination, the spatial separation between elements is the distance between them when projected onto the axis of direction determination. The axis of direction determination can be, but is not limited to, the azimuth or the elevation axes. In this example illustrated in FIG. 4A, n is an integer greater than or equal to 2. The distances between adjacent antennas for the situation where n is 3 or greater need not be equal. Spatially separated antennas in the axis of target direction determination can be used for any of the antenna arrangements shown in FIGS. 3A-F, or within the Transmit Antenna Network 601 and/or Receive Antenna Network 621 according to aspects of the present invention.

Another example of antenna spatial separation is illustrated in FIG. 4B according to aspects of the present invention. The example of antenna spatial separation shown in FIG. 4B is for illustration purposes and is not considered a limitation. In this arrangement, k+1 antennas 157, 159, 160 are separated from one another by distances D_{k,1} and D_{k+1,k} in the axis of target direction determination as shown in FIG. 4B. For antennas that are not aligned in the axis of direction determination, the spatial separation between elements is the distance between them when projected onto the axis of direction determination. The axis of direction determination can be, but is not limited to, the azimuth or the elevation axes. In this example illustrated in FIG. 4B, k is an integer greater than or equal to 2. The distances between adjacent antennas need not be equal. Spatially separated antennas in the axis of target direction determination can be used for any of the antenna arrangements shown in FIGS. 3A-F, or within the Transmit Antenna Network 601 and/or Receive Antenna Network 621 according to aspects of the present invention.

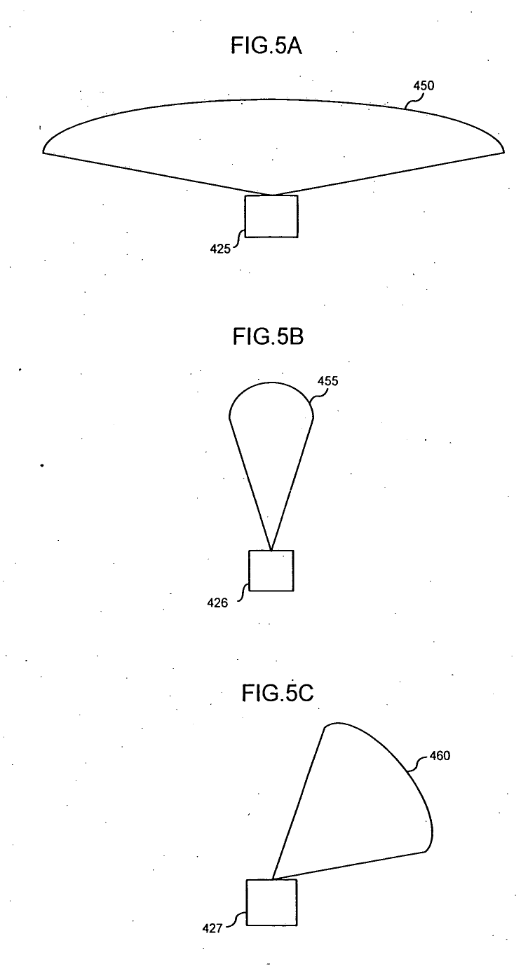

One example of an antenna beam shape is illustrated in FIG. 5A according to aspects of the present invention. The example of antenna beam shape shown in FIG. 5A is approximate, with side lobes omitted, for illustration purposes only, and is not considered a limitation. In this example, an antenna 425 is shown with a wide angle beam pattern 450. The term “wide” with respect to the beam pattern refers to a main-lobe with a −3 dB beam width that can have, but is not limited to, a value greater than or equal to 90 degrees, 100 degrees, 110 degrees, 120 degrees, 130 degrees, 140 degrees, 150 degrees, 160 degrees, or 170 degrees. The antenna beam shape illustrated can be used for any of the antenna arrangements shown in FIGS. 3A-F, or within the Transmit Antenna Network 601 and/or Receive Antenna Network 621 according to aspects of lo the present invention. The generation of a wide beam pattern for near-distance sensing can be desirable to reduce sensor count for cost reduction.

Another example of an antenna beam shape is illustrated in FIG. 5B according to aspects of the present invention. The example of antenna beam shape shown in FIG. 5B is approximate, with side lobes omitted, for illustration purposes only, and is not considered a limitation. In this example, an antenna 426 is shown with a narrow angle beam pattern 455. The term “narrow” with respect to the beam pattern refers to a main-lobe with a −3 dB beam width that can have, but is not limited to, a value less than 90 degrees, 80 degrees, 70 degrees, 60 degrees, 50 degrees, 40 degrees, 30 degrees, 20 degrees, or 10 degrees. The antenna beam shape illustrated can be used for any of the antenna arrangements shown in FIGS. 3A-F, or within the Transmit Antenna Network 601 and/or Receive Antenna Network 621 according to aspects of the present invention.

A further example of an antenna beam shape is illustrated in FIG. 5C according to aspects of the present invention. The example of antenna beam shape shown in FIG. 5C is approximate, with side lobes omitted, for illustration purposes only, and is not considered a limitation. In this example, an antenna 427 is shown with a directional beam pattern 460. This example illustrates that antenna beam shapes need not be limited to those pointing in the boresight direction, but rather can have any direction within the sensor's overall field-of-view. The antenna beam shape illustrated can be used for any of the antenna arrangements shown in FIGS. 3A-F, or within the Transmit Antenna Network 601 and/or Receive Antenna Network 621 according to aspects of the present invention.

Any combination of the antenna beam shapes or characteristics illustrated in FIGS. 5A-C can be used for any of the antenna arrangements shown in FIGS. 3A-F, or within the Transmit Antenna Network 601 and/or Receive Antenna Network 621 according to aspects of the present invention. In addition, by switching between different beam patterns, target detection zones can be established and selectively enabled, disabled, or switched between. Furthermore, antenna beams can be switched between for the purpose of, but not limited to, target angular discrimination, clutter rejection, or ambiguity resolution in directional processing.

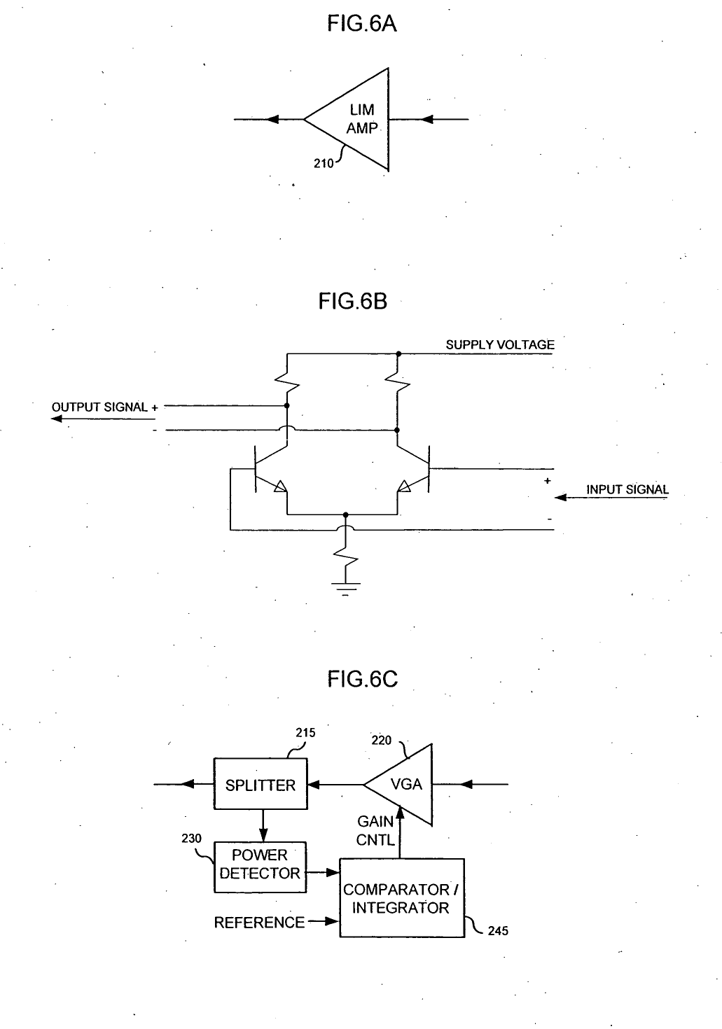

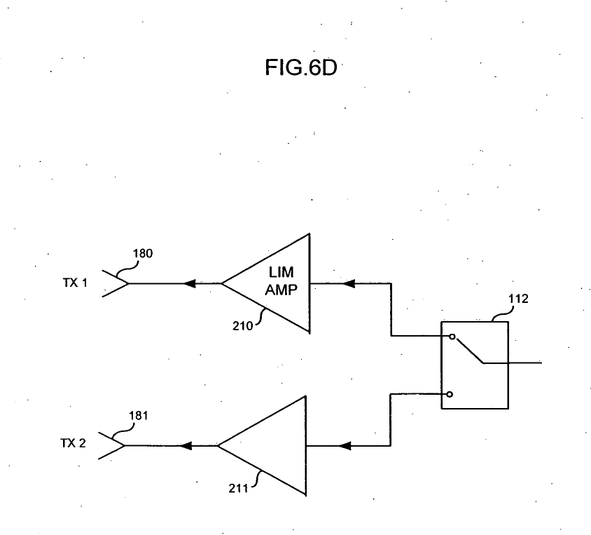

One example of a transmit power limiting circuit arrangement is illustrated in FIG. 6A according to aspects of the present invention. This circuit arrangement can be used, for example, within the Transmit Power Limited Stepped Frequency Modulation Transmitter 655 or as appropriate in other transmission components, such as, but not limited to, antenna selection blocks, for the purpose of providing limiting and/or control of the transmit power for the radar sensor described in FIG. 2B. In this circuit arrangement, a limiting amplifier such as, but not limited to, a differential pair/current switch, is used to provide an output signal with a stable output amplitude and/or power. A simplified circuit diagram of an example of a differential pair/current switch circuit is shown in FIG. 6B. By using a limiting amplifier, output signal amplitude variations due to input signal amplitude variations can be reduced or eliminated. Furthermore, variation of the output amplitude, or transmit power, due to temperature variation can be reduced or eliminated. By tightly controlling the output amplitude, or output power, it is possible to ensure that legislative output power limits are not exceeded, while at the same time allowing maximal output power within the limits such that SNR can be preserved.

Another example of a transmit power limiting circuit arrangement is illustrated in FIG. 6C according to aspects of the present invention. This circuit arrangement can be used within the Transmit Power Limited Stepped Frequency Modulation Transmitter 655 for the purpose of providing limiting and/or control of the transmit power for the radar sensor described in FIG. 2B. In this circuit arrangement, a variable gain amplifier (VGA) 220 is used to provide an output signal with a stable output amplitude and/or power. The output of VGA 220 is split by signal splitter 215 with one of the split signals being input to a power detector 230. The output of the power detector 230 is input to a comparator/integrator 245 where it is compared with a reference. The output of the comparator/integrator is the integrated difference signal which is used to control the gain of the VGA 220. In this way, a power control feedback loop is established such that the power of the output signal from VGA 220 is controlled. By using this circuitry arrangement, output signal amplitude variations of VGA 220 due to input signal amplitude variations can be reduced or eliminated. Furthermore, variation of the output amplitude, or output power, from VGA 220 due to temperature variation can be reduced or eliminated. By tightly controlling the output amplitude, or output power, it is possible to ensure that legislative output power limits are not exceeded while at the same time allowing maximal output power within the limits such that SNR can be preserved.

An example of a switched transmitter circuit arrangement is illustrated in FIG. 6D according to aspects of the present invention. In this circuit arrangement, a limiting amplifier 210 can be switched into operation by selection switch 112 to transmit in a low transmit power limited band of operation, such as a UWB band of operation, and can utilize a certain detection zone dictated by the associated transmit antenna 180, and the amplifier 211 can be switched into operation by selection switch 112 to transmit a higher power level in a higher allowed transmit power band of operation, such as an ISM band of operation, and can utilize a certain detection zone dictated by the associated transmit antenna 181. One benefit of this arrangement can be to allow the radar sensor to achieve a longer range operation with a lower range resolution, while also providing a higher range resolution for shorter range operation. This arrangement is meant as an example, not as a limitation, as other circuit arrangements can be utilized to achieve the same function as is described.

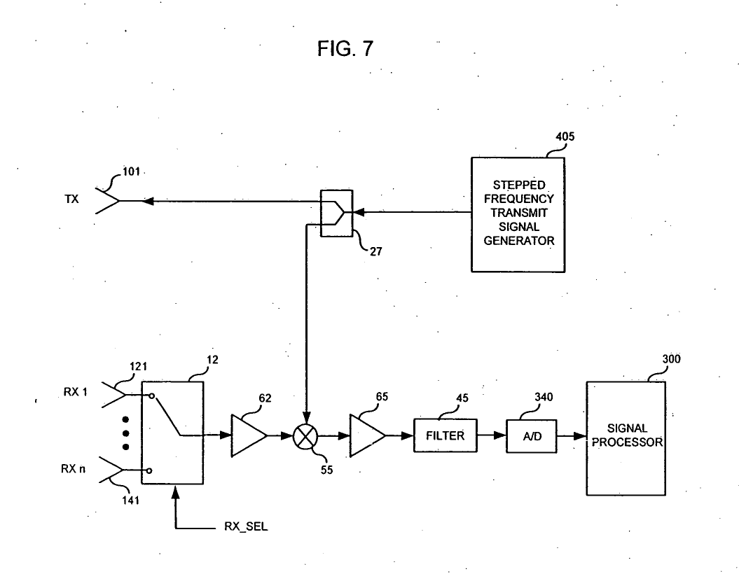

A radar sensor arrangement is presented in FIG. 7 as one embodiment of aspects of the present invention. In this arrangement, a stepped frequency modulated transmit signal generated by the Stepped Frequency Transmit Signal Generator 405 is split by a splitter 27, where one portion of the signal proceeds to an antenna means 101 for transmission of the signal towards a target. A typical frequency of the output signal from the Stepped Frequency Transmit Signal Generator 405 can be within, but is not limited to, the frequency range of 22 GHz-29 GHz or 76 GHz-81 GHz. The radar sensor's total occupied transmit spectral bandwidth is dependent on the radar frequency modulation bandwidth, and can be ultra-wideband (UWB) to achieve increased range resolution for some automotive applications. The reflected signal from a target will be received by an array of n receiver antennas 121, 141, designated by RX 1, RX n, where n is an integer greater than or equal to 2. The n receiver antennas are arrayed and spatially separated from each other in each axis in which target angular direction is to be determined. A selection switch 12 is used to selectively connect one receiver antenna at a time with the receiver/down-converter for the radar sensor in a sequential manner. The selection switch is controlled by a signal designated as RX₁₃ SEL. The receiver/down-converter for the radar sensor consists of a low noise amplifier 62 where the received signal is amplified prior to being input to down-converting mixer 55, where the signal is mixed with one output signal from signal splitter 27, and the resulting signal is amplified by amplifier 65 and filtered by filter 45. After filtering by filter 45, the resulting signal is then digitized by analog-to-digital converter 340 and input to a signal processor 300 for signal processing. During the dwell time for each receiver antenna in the receiver array, the signal segment corresponding to that antenna's spatial position is digitized and stored for use as part of a spatially separated signals processing method.

The block diagram shown in FIG. 7 can be modified according to aspects of the present invention. One example of such a modification, not meant as a limitation, can be to replace mixer 55 with an I/Q complex mixer for complex signal down-conversion and modify the block diagram accordingly. Another example of such a modification, not meant as a limitation, can be for the radar sensor architecture to use remote signal processing, remote analog-to-digital (A/D) conversion, or shared processing and/or A/D conversion. A further example of such a modification, not meant as a limitation, can be for the radar sensor architecture to replace the selection switch 12 with a plurality of switched amplifiers and signal combiners, utilizing the gain/loss of the switched amplifiers to realize an antenna selection and routing function. A yet further example of such a modification, not meant as a limitation, can be for the radar sensor architecture to share an RX antenna with the TX antenna function, or to utilize a plurality of switched TX antennas in combination with the switched RX antennas to synthesize a receive antenna array. Mixer 55 can be implemented by, but is not limited to, a mixer, multiplier, or switch without changing the basic functionality of the arrangement. Filter 45 can be implemented by, but is not limited to, a low-pass filter or band-pass filter. Signal splitter 27 can be implemented by, but is not limited to, a Wilkinson power divider, passive splitter, active splitter, or microwave coupler. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to the described arrangement, or the position of existing elements may be modified, without changing the basic form or spirit of the invention.

Signal processor 300 may comprise a single or plurality of individual processors. Signal processor 300 may perform, but is not limited to, any single or combination of the functions of spatially separated signals processing, real or complex DFT or FFT signal processing, CFAR threshold detection, spectral peak detection, target peak association, frequency measurement, magnitude measurement, phase measurement, magnitude scaling, phase shifting, phase monopulse, amplitude monopulse, interferometry, spatial FFT processing, digital beam-forming (DBF) processing, digital multi-zone monopulse (DMM) processing, super-resolution processing, target angle calculation, target range calculation, and target velocity calculation. Spatially separated signals processing may include, but is not limited to, phase monopulse, amplitude monopulse, interferometry, spatial FFT processing, digital beam-forming (DBF) processing, digital multi-zone monopulse (DMM) processing, or super-resolution algorithms such as multiple signal classification (MUSIC) or estimation of signal parameters via rotational invariance techniques (ESPRIT). Furthermore, the spatially separated signals processing techniques can be used separately or in any combination, and can be combined with other techniques such as multilateration, or switched-beam detection zone discrimination for the purpose of improving angle calculation performance, reduction in false alarms, improvement in multiple target discrimination, reduction in clutter returns, or reduction in processor loading. In addition, different processing techniques may be used at different times or for different detections zones, target ranges, or for other advantage. Target angle calculation processing may include, but is not limited to, phase shifting, amplitude scaling, spectral peak phase measurement, spectral peak amplitude measurement, or spectral peak frequency measurement. Target range calculation processing may include, but is not limited to, spectral peak frequency measurement, spectral peak phase measurement, or signal envelope amplitude measurement. Target velocity calculation processing may include, but is not limited to, Doppler processing or derivation through successive time target measured positions. Target velocity derived from Doppler processing can also be used as a target discrimination means to aid in target separation and processing, especially in the situation where multiple target returns are from the same range or within the same range bin of the radar. Additional processing techniques used in the abovementioned functions may include, but are not limited to, windowing, digital filtering, Hilbert transform, least squares algorithms, or non-linear least squares algorithms. The signal processor may include, but is not limited to, a digital signal processor (DSP), microprocessor, microcontroller, electrical control unit, or other suitable processor block. Furthermore, target velocity can be determined externally from the radar sensor unit, such as in an external processor or on the radar system level, without departing from the spirit of the present invention.

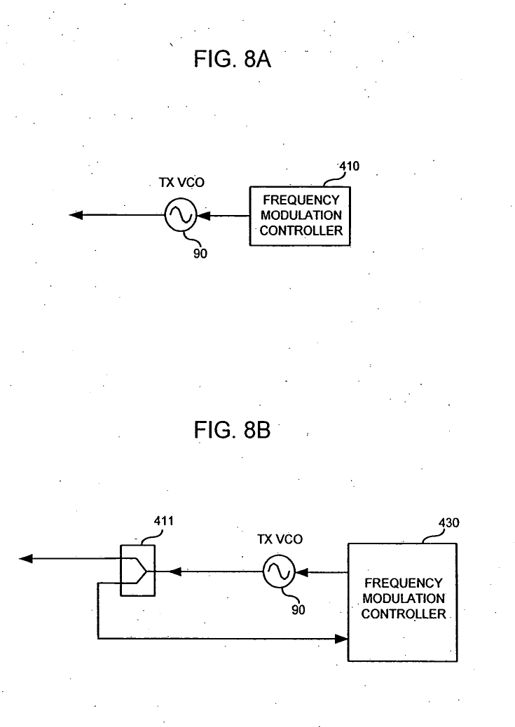

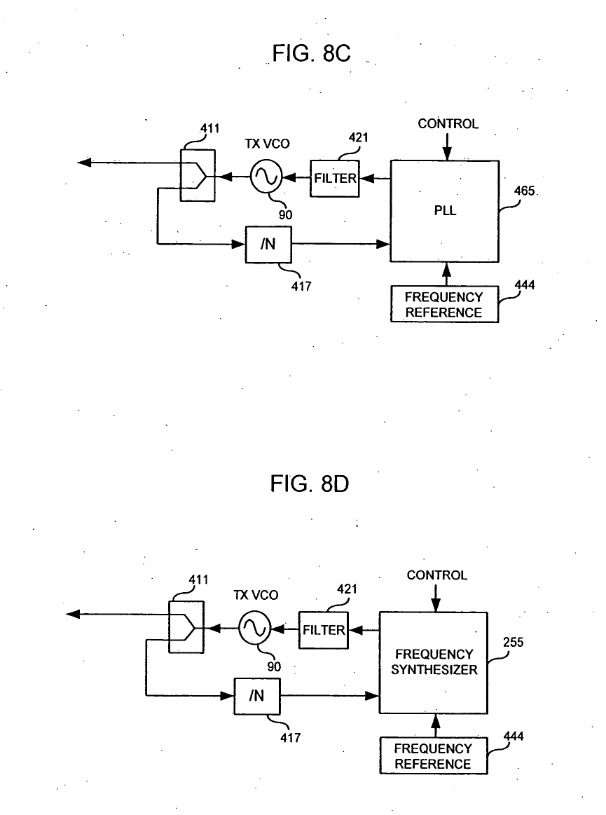

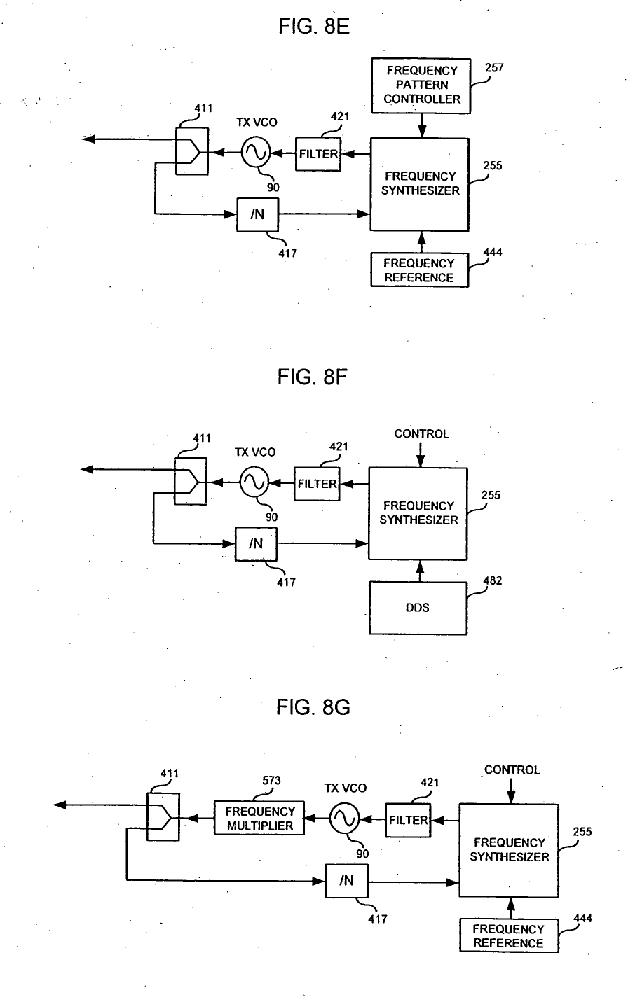

One embodiment of Stepped Frequency Transmit Signal Generator 405 is shown in FIG. 8A. In this configuration, a Frequency Modulation Controller 410 controls the frequency modulation of a transmit voltage-controlled-oscillator 90. The Frequency Modulation Controller 410 can be implemented by, but is not limited to, a stepped frequency waveform generator, or a frequency hopping waveform generator. The embodiment shown in FIG. 8A represent an open-loop transmit signal generator configuration. The configurations shown are meant as an illustration of stepped frequency transmit signal generation techniques, not as a limitation. Other open-loop, stepped frequency transmit signal generation techniques can be implemented by one of ordinary skill in the art without departing from the spirit of the present invention.

Another embodiment of Stepped Frequency Transmit Signal Generator 405 is shown in FIG. 8B. In this configuration, the output of a Frequency Modulation Controller 430 controls the frequency modulation of a transmit voltage-controlled-oscillator 90. The Frequency Modulation Controller 430 can be implemented by, but is not limited to, a stepped frequency waveform generator, or a frequency hopping waveform generator. The output signal from the Frequency Modulation Controller 430 is split by signal splitter 411, where one portion of the signal is output, and the other portion of the signal is fed back to the Frequency Modulation Controller 430 forming a closed-loop transmit signal generator.

A further embodiment of Stepped Frequency Transmit Signal Generator 405 is shown in FIG. 8C. In this configuration, the output of a phase-locked loop (PLL) 465 is used to control the frequency of a transmit voltage-controlled-oscillator (TX VCO) 90. The output from TX VCO 90 is split by splitter 411, where one portion of the signal is output, while the other portion of the signal is frequency divided by N by divider 417 and fed back to the PLL 465 forming a closed-loop transmit signal generator. A frequency reference 444 is input to the PLL 465, and the PLL 465 is controlled by an external control signal.

A yet further embodiment of Stepped Frequency Transmit Signal Generator 405 is shown in FIG. 8D. In this configuration, the output of a frequency synthesizer 255 is used to control the frequency of a transmit voltage-controlled-oscillator (TX VCO) 90. The output from TX VCO 90 is split by splitter 411, where one portion of the signal is output, while the other portion of the signal is frequency divided by N by divider 417 and fed back to the frequency synthesizer 255 forming a closed-loop transmit signal generator. A frequency reference 444 is input to the frequency synthesizer 255, and the frequency synthesizer 255 is controlled by an external control signal.

Another embodiment of Stepped Frequency Transmit Signal Generator 405 is shown in FIG. 8E. In this configuration, the output of a frequency synthesizer 255 is used to control the frequency of a transmit voltage-controlled-oscillator (TX VCO) 90. The output from TX VCO 90 is split by splitter 411, where one portion of the signal is output, while the other portion of the signal is frequency divided by N by divider 417 and fed back to the frequency synthesizer 255 forming a closed-loop transmit signal generator. A frequency reference 444 is input to the frequency synthesizer 255, and the frequency modulation pattern of the frequency synthesizer 255 is controlled by a frequency pattern controller 257.

A further embodiment of Stepped Frequency Transmit Signal Generator 405 is shown in FIG. 8F. In this configuration, the output of a frequency synthesizer 255 is used to control the frequency of a transmit voltage-controlled-oscillator (TX VCO) 90. The output from TX VCO 90 is split by splitter 411, where one portion of the signal is output, while the other portion of the signal is frequency divided by N by divider 417 and fed back to the frequency synthesizer 255 forming a closed-loop transmit signal generator. A direct-digital-synthesizer (DDS) 482 is input as a frequency reference to the frequency synthesizer 255. Through the control of the DDS 482 frequency, the modulation of the TX VCO 90 frequency can be controlled. The embodiments shown in FIGS. 8B-F represent closed-loop transmit signal generator configurations. The configurations shown are meant as an illustration of stepped frequency transmit signal generation techniques, not as a limitation. Other closed-loop, stepped frequency transmit signal generation techniques can be implemented by one of ordinary skill in the art without departing from the spirit of the present invention.

A yet further embodiment of Stepped Frequency Transmit Signal Generator 405 is shown in FIG. 8G. The arrangement in FIG. 8G is similar to the arrangement in FIG. 8D except for the use of a frequency multiplier 573 at the output of transmit voltage-controlled-oscillator (TX VCO) 90. The same components are denoted by the same reference numerals, and will not be explained again. The use of a frequency multiplier 573 allows the frequency of TX VCO 90 to be lower than the output transmit frequency of the Stepped Frequency Transmit Signal Generator 405.

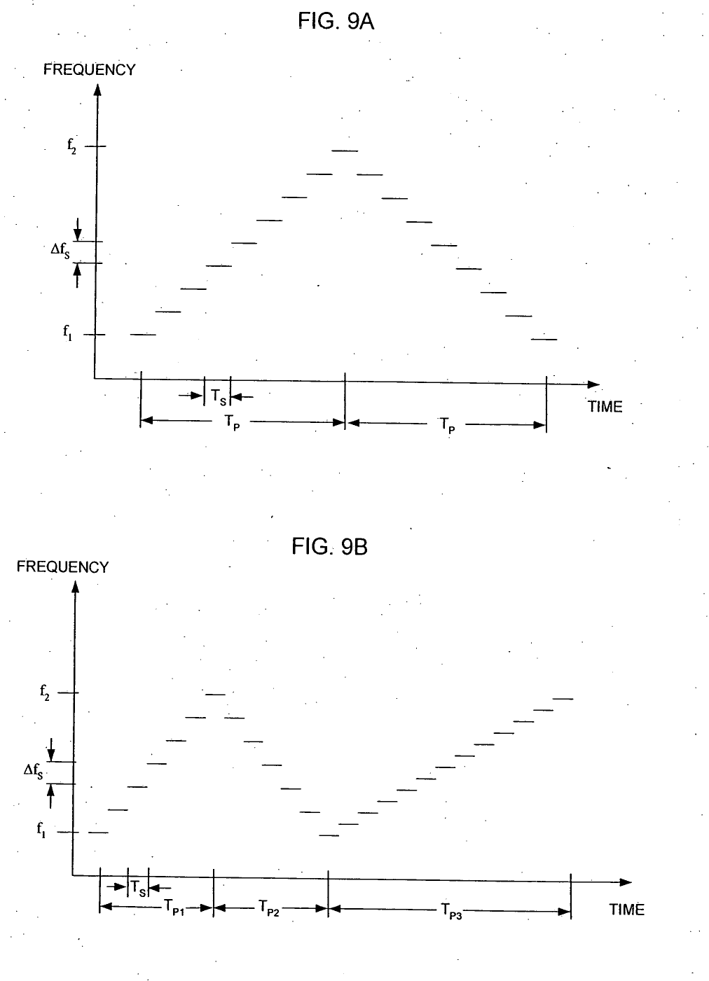

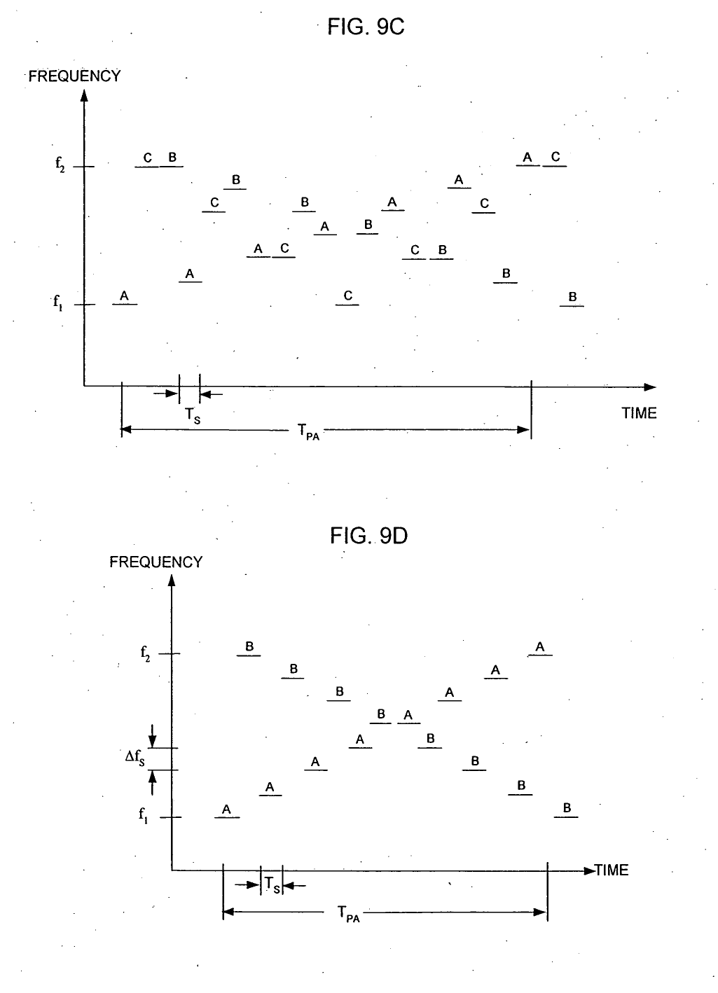

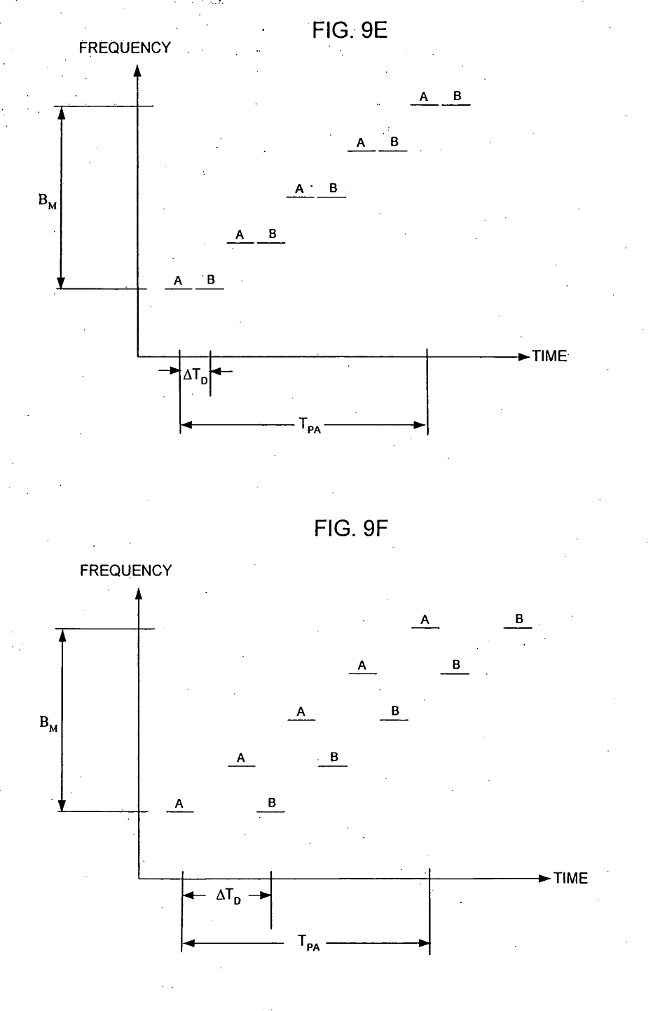

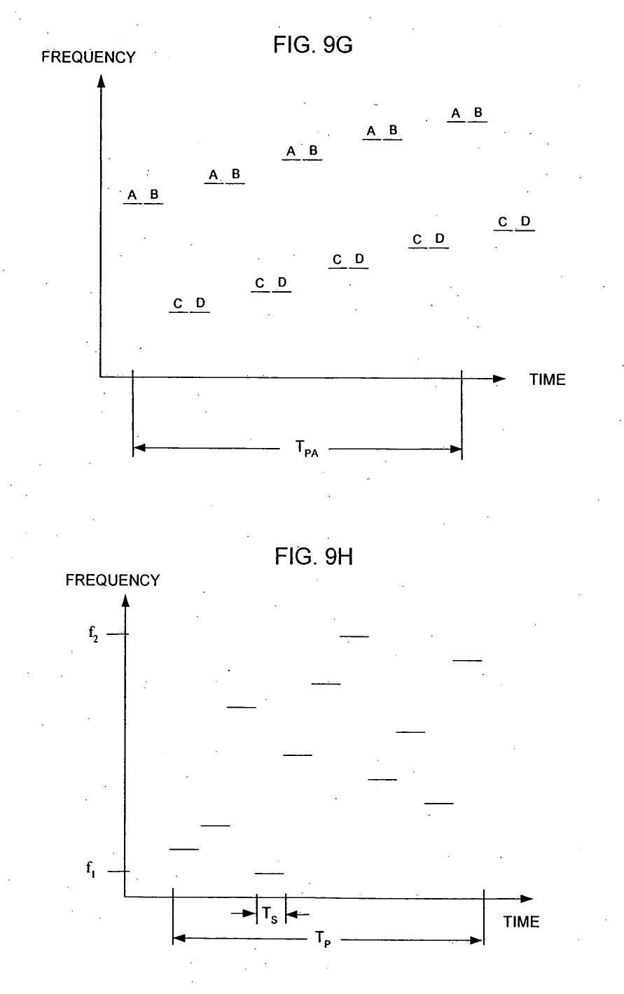

FIG. 9A illustrates a stepped frequency modulation waveform for use in the Stepped Frequency Transmit Signal Generator 405 according to aspects of the present invention. This waveform shows a linearly stepped frequency pattern with a frequency increasing step sequence period and decreasing step sequence period each equal to T_{P}. This waveform shown is an example of linearly stepped frequency modulation and is not meant as a limitation. A typical value of □ f_{S} can be within, but is not limited to, the range of 100 KHz-20 MHz. A typical value of T_{S} can be within, but is not limited to, the range of 500 nanoseconds (ns)-20 microseconds (us). The waveform can also comprise, but is not limited to, a repeating pattern of linearly increasing frequency steps, a repeating pattern of linearly decreasing frequency steps, or alternating periods of linearly increasing and decreasing frequency step patterns. Also, periods where the stepped frequency modulation pattern is stopped may be inserted into the abovementioned patterns. In addition, the value of Tₛ may be varied or dithered, or the linearity of the frequency steps with respect to time may be slightly varied by one skilled in the art without departing from the spirit of the present invention. Furthermore, to achieve high-resolution range radar performance, the total frequency modulation bandwidth, defined as |f₂−f₁| in FIG. 9A, can be ultra-wideband (UWB).

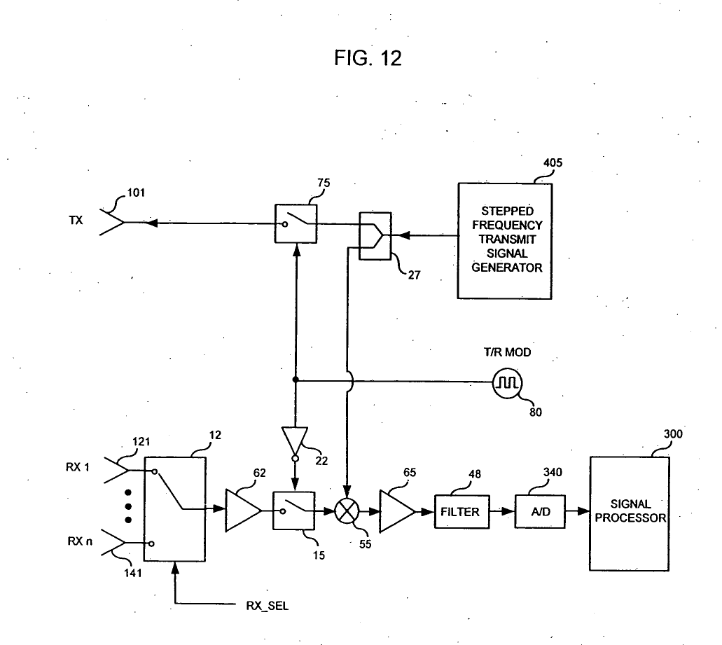

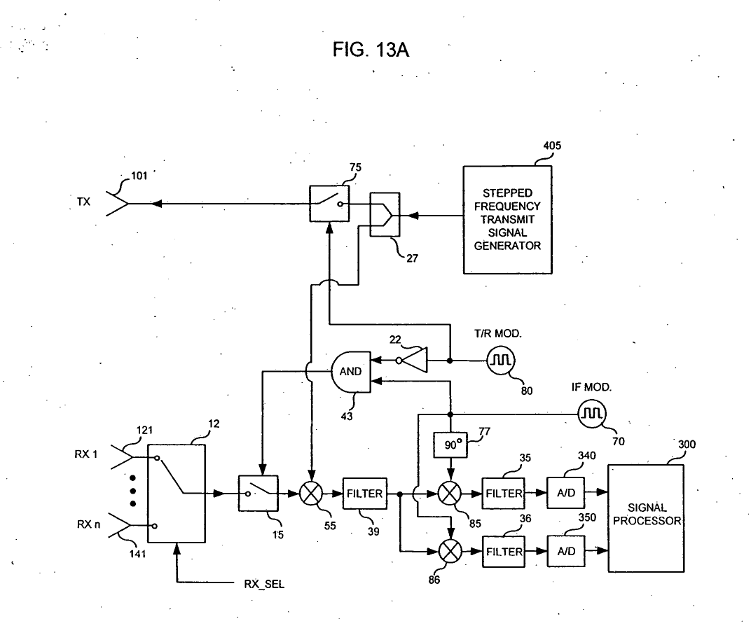

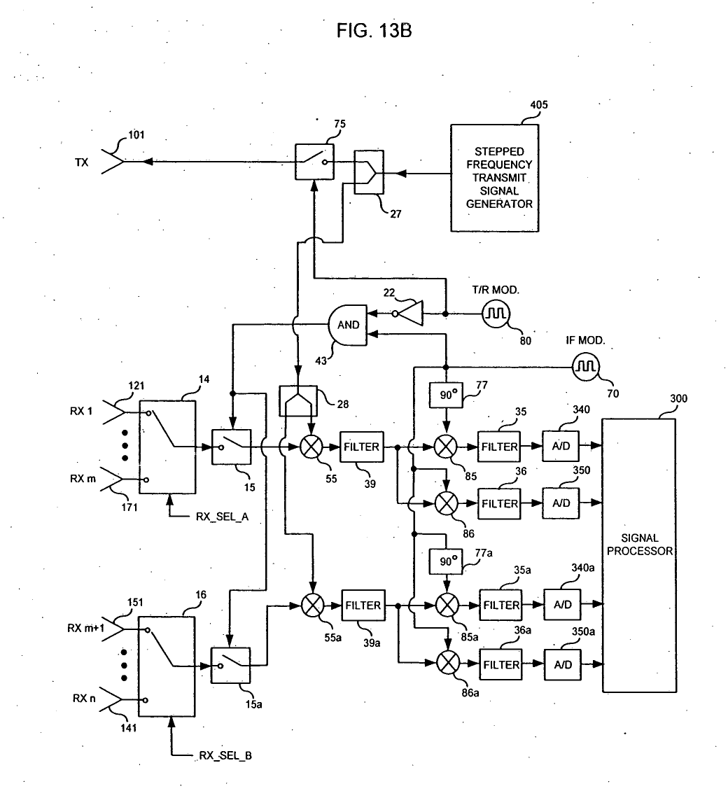

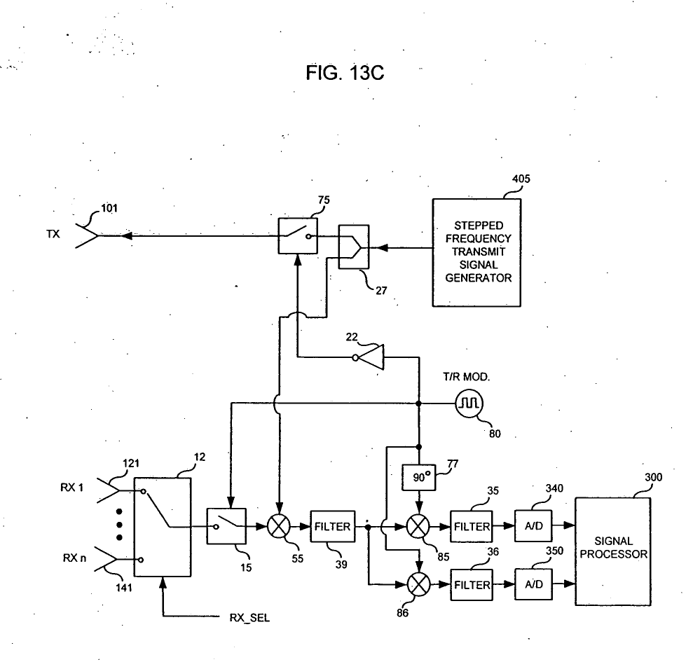

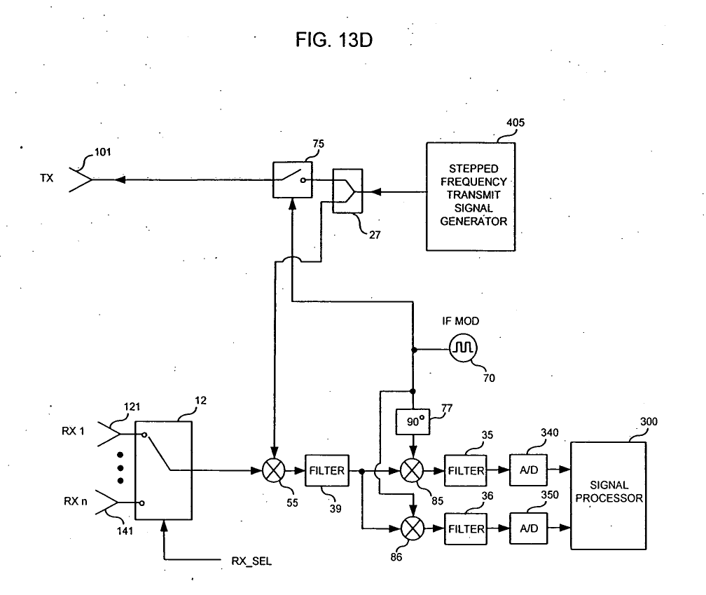

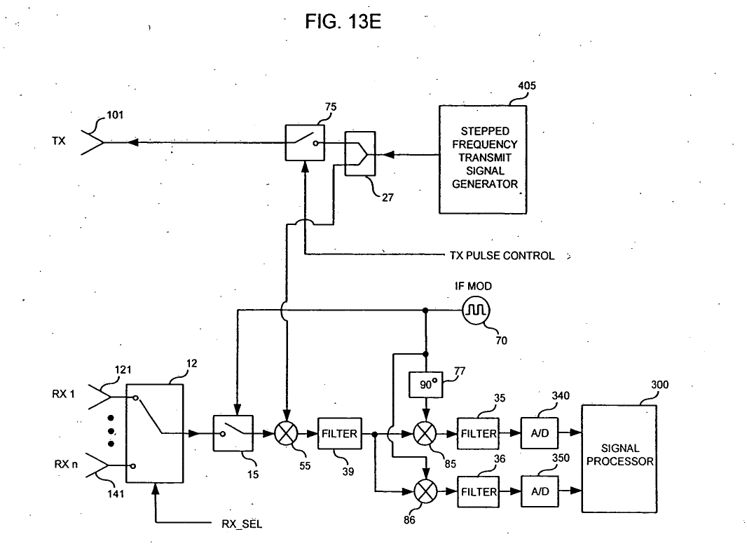

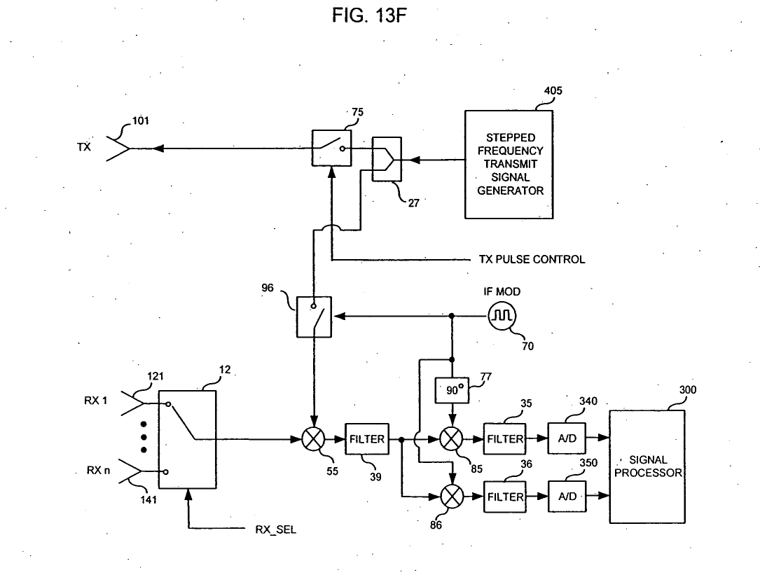

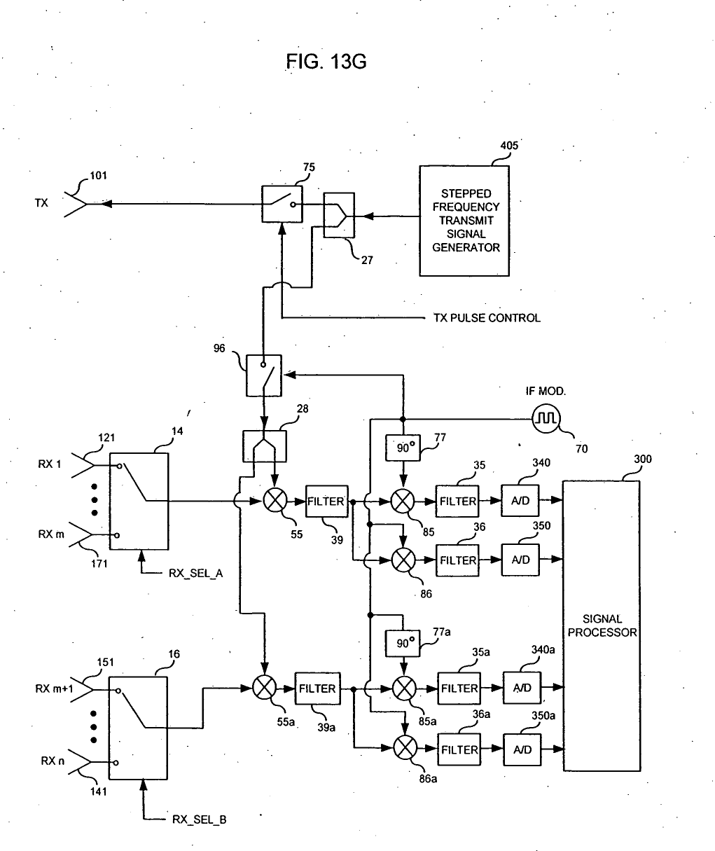

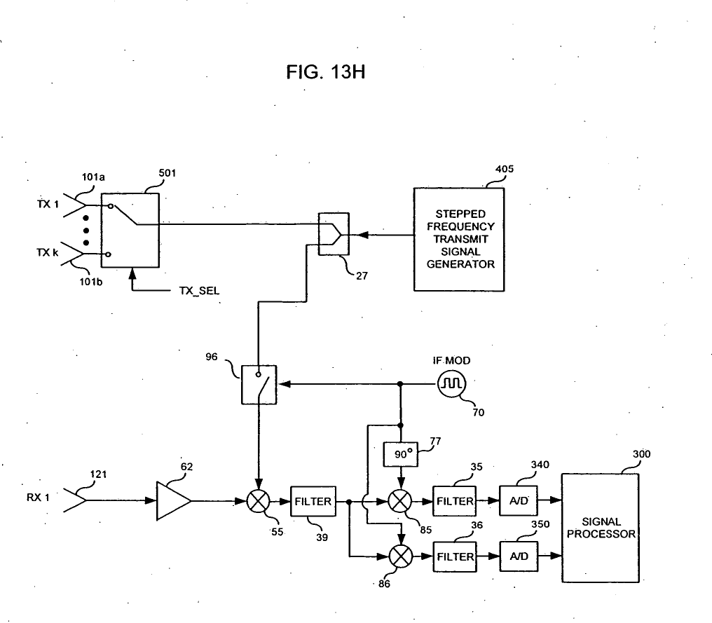

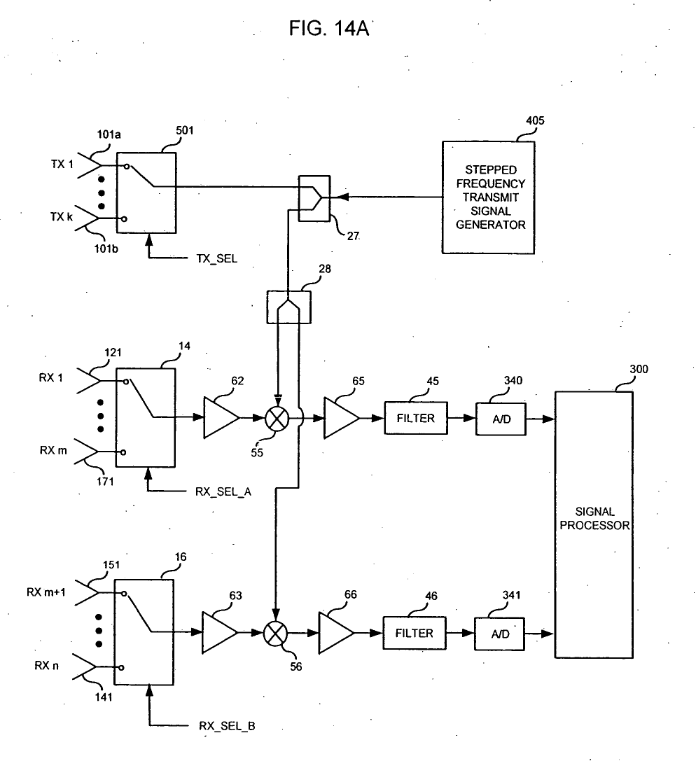

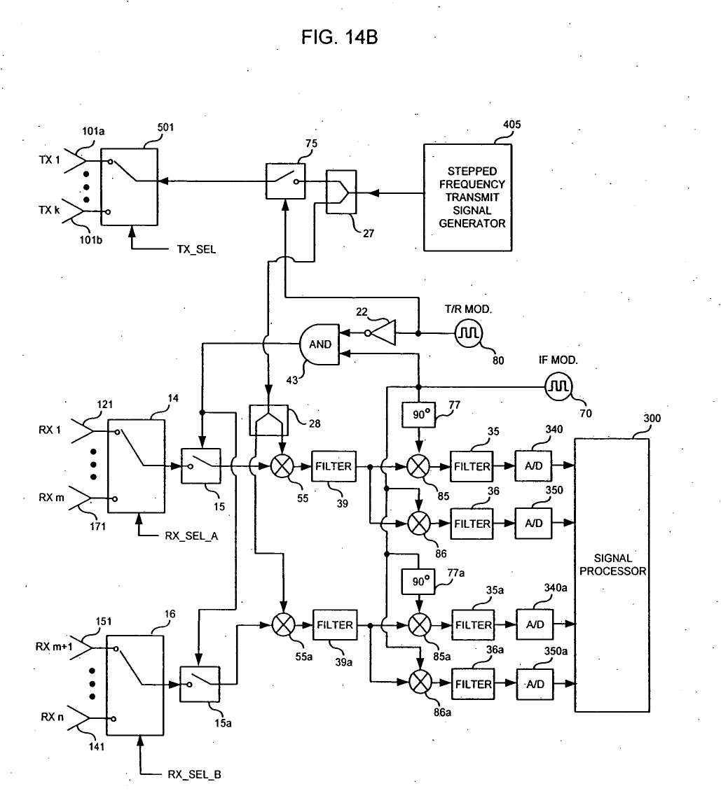

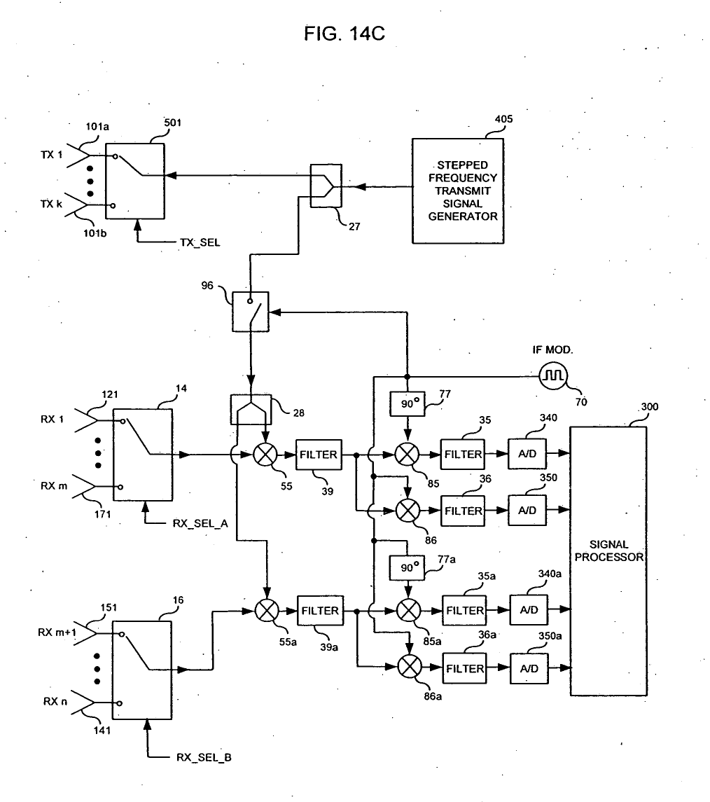

Using the frequency modulation waveform described in FIG. 9A, target information may be calculated from the digitized down-converted signals of the architectures shown in FIGS. 2A-B, FIG. 7, FIG. 11, FIG. 12, FIGS. 13A-H, and FIGS. 14A-C in the following way. Peaks in the digitized down-converted signal spectrum represent target returns. The frequency of the target peaks is proportional to target range and is used to calculate target range. As an example, not meant in any way as a limitation, let the radar arrangement of FIG. 7 utilize a linearly increasing frequency step sequence and linearly decreasing frequency step sequence as shown in FIG. 9A. Let the down-converted signal be sampled & measured during each coherent measurement interval T_{P}, which for this example also corresponds to the frequency increasing step sequence period and decreasing step sequence period. Under these conditions, target range can be calculated by the following equation:

$$R = \frac{c \cdot {T}_{S}}{4 \cdot Δ {f}_{S}} \cdot ( {f}_{U} + {f}_{D} ) \qquad ( 1 )$$

where R is the calculated target range, c is the speed of light in a vacuum, T_{S} is dwell time of each frequency step, □f_{S} is the difference between adjacent frequency step values in the linear step sequence, and f_{U} and f_{D} are the beat frequencies in the down-converted signal corresponding to measurements during the frequency increasing sequence and frequency decreasing sequence periods T_{P} respectively.

The Doppler frequency shift of the target frequency peaks in measured across the digitized down-converted signal spectrum is used to calculate target relative velocity. As an example, not meant in any way as a limitation, let the radar arrangement of FIG. 7 utilize a linearly increasing frequency step sequence and linearly decreasing frequency step sequence as shown in FIG. 9A. Let the down-converted signal be sampled once per frequency step in each sequence, and measured during each coherent measurement interval T_{P}, which for this example also corresponds to the frequency increasing step sequence period and decreasing step sequence period. Under these conditions, target relative velocity can be calculated by the following equation:

$$V = \frac{c}{2 \cdot ( {f}_{1} + {f}_{2} )} \cdot ( {f}_{D} - {f}_{U} ) \qquad ( 2 )$$

where V is the calculated target relative velocity defined as positive for an approaching target, c is the speed of light in a vacuum, f₁ and f₂ are the minimum and maximum frequency steps in the linear sequence during a coherent measurement period T_{P}, and f_{U} and f_{D} are the beat frequencies in the digitized down-converted signal corresponding to the measurements during the frequency up-step sequence and down-step sequence periods T_{P} respectively. It should be noted that to determine target range and relative velocity without ambiguity, the use of measurements from both a frequency increasing step sequence period and decreasing step sequence period are required, as illustrated in equations (1) and (2). Thus, using the waveform illustrated in FIG. 9A, a time duration of 2*T_{P} is required to gather the measurement data required to determine a target's range and relative velocity, limiting the radar sensor's update period to greater than or equal to 2*T_{P}.

An alternate approach to calculating target range is to use an inverse fast Fourier transform (IFFT) or inverse discrete Fourier transform (IDFT), after sampling the down-converted signal, to build a target range profile. The peaks in the IFFT or IDFT profile represent target returns with range proportional to the peak's associated time bin.

FIG. 9B illustrates a stepped frequency modulation waveform for use in the Stepped Frequency Transmit Signal Generator 405 according to aspects of the present invention. This waveform comprises multiple linearly stepped frequency patterns of varying slopes □f_{S}/ T_{S}. The waveform shown is an example of linearly stepped frequency modulation, and is not meant as a limitation. Also, periods where the stepped frequency modulation pattern is stopped may be inserted into the abovementioned patterns. In addition, the value of T_{S} may be varied or dithered, or the linearity of the frequency steps with respect to time may be slightly varied by one skilled in the art without departing from the spirit of the present invention. Furthermore, to achieve high-resolution range radar performance, the total frequency modulation bandwidth, defined as |f₂−f₁| in FIG. 9B, can be ultra-wideband (UWB).

Using the type of frequency modulation waveform described in FIG. 9B, target information may be calculated from the digitized down-converted signals of the architectures shown in FIGS. 2A-B, FIG. 7, FIG. 11, FIG. 12, FIGS. 13A-H, and FIGS. 14A-C in the following way. As an example, not meant in any way as a limitation, let the radar arrangement of FIG. 7 utilize three linearly stepped frequency sequences as shown in FIG. 9B. Let the down-converted signals be sampled once per frequency step in each sequence, and measured separately during each coherent measurement interval T_{P1}, T_{P2}, and T_{P3}. Under these conditions, the relationship between target range and relative velocity for each frequency peak in each separate down-converted signal spectrum can be determined by the following equation:
fⱼ=2·Rⱼ·□f_{S}/(c·T_{S})+2·Vⱼ/□ (3)
where fⱼ is the measure frequency of the j^{th} peak in the spectrum of the down-converted difference signal, Rⱼ is range and Vⱼ is the relative velocity corresponding to the j^{th} peak in the spectrum of the down-converted difference signal, □f_{S} is the frequency step increment for the stepped frequency sequence under evaluation, c is the speed of light in a vacuum, T_{S} is the frequency step dwell time of the stepped frequency sequence under evaluation, and □ is the average wavelength of the stepped frequency sequence under evaluation. By graphing each separate equation (3) generated for each separate frequency peak together on one graph with range as one axis and relative velocity as the other axis, valid targets will appear only where three lines intersect at a single point, with a correct range and relative velocity determined by the position on the graph of that intersection point. One benefit of the use of multiple slopes of linearly frequency stepped waveforms is that this assists in the removal of false or “ghost” targets in the signal processing of multiple target environments, and aids in the resolution of the range-velocity ambiguity. It should be noted that using the waveform and method illustrated in FIG. 9B, a time duration of T_{P1}+T_{P2}+T_{P3} is required to gather the measurement data required to determine target range and relative velocity, limiting the radar sensor's update period to greater than or equal to T_{P1}+T_{P2}+T_{P3}. In addition, the order in which waveforms are sequenced and/or the start times for the waveforms can be varied between update periods. One benefit of such variation can be to reduce potential interference or to provide an increased immunity to interference. Such parameters can be varied continuously and/or randomly after each update period which may eliminate the need for interference detection, identification, and response circuitry.

FIG. 9C illustrates a stepped frequency modulation waveform for use in the Stepped Frequency Transmit Signal Generator 405 according to aspects of the present invention. This waveform comprises multiple linearly stepped frequency patterns intertwined. The individual stepped frequency patterns can have multiple slopes □f_{S}/T_{S} as described in FIG. 9B, be increasing, or decreasing. Also, periods where the stepped frequency modulation pattern is stopped may be inserted into the abovementioned patterns. Furthermore, the order in which waveform patterns are intertwined can also be varied or randomized from measurement prior to measurement period, which can be of benefit for interference reduction and/or channelization. In this example, the three individual sequences A, B, and C each have equal coherent processing interval durations T_{PA}=T_{PB}=T_{PC}=T_{P}, with only the coherent processing interval T_{PA} for sequence A shown for clarity. To achieve high-resolution range radar performance, the total frequency modulation bandwidth, defined as |f₂−f₁| in FIG. 9C, can be ultra-wideband (UWB). In addition, the order in which waveforms are intertwined and/or the start times for the waveforms can be varied between subsequent coherent processing intervals. One benefit of such variation between subsequent coherent processing intervals can be to reduce potential interference or to provide an increased immunity to interference. Such parameters can be varied continuously and/or randomly after each coherent processing interval which may eliminate the need for interference detection, identification, and response circuitry.

Using the type of stepped frequency pattern described in FIG. 9C, target information may be calculated from the digitized down-converted signals shown in FIGS. 2A-B, FIG. 7, FIG. 11, FIG. 12, FIGS. 13A-H, and FIGS. 14A-C in a manner similar to that as described for the frequency modulation pattern of FIG. 9B, with the exception that A/D samples of the down-converted signals must be correctly associated with their corresponding pattern A, B, or C and de-intertwined before spectral processing such as, but not limited to, a Fourier transform or inverse Fourier transform. One benefit of using the waveform and method illustrated in FIG. 9C is that only a period of approximately T_{PA} is required to gather the measurement data required to determine target range and relative velocity, improving the update rate of target range and relative velocity for the radar sensor as compared to the waveforms illustrated in FIGS. 9A and 9B. Reduced update periods are especially important for short-range sensors where short reaction times can be required.

FIG. 9D illustrates a stepped frequency modulation waveform for use in the Stepped Frequency Transmit Signal Generator 405 according to aspects of the present invention. This waveform is comprised of two linearly stepped frequency sequences intertwined, one having an equal but negative slope □f_{S}/T_{S} with respect to the other the other, during a predetermined time interval. Also, to achieve high-resolution range radar performance, the total frequency modulation bandwidth, defined as |f₂−f₁| in FIG. 9D, can be ultra-wideband (UWB).

Using the type of stepped frequency pattern described in FIG. 9D, target information may be calculated from the digitized down-converted signals shown in FIGS. 2A-B, FIG. 7, FIG. 11, FIG. 12, FIGS. 13A-H, and FIGS. 14A-C in a manner similar to that as described for the frequency modulation pattern of FIG. 9A, with the exception that A/D samples of the down-converted signals must be correctly associated with their corresponding pattern A or B and de-intertwined before spectral processing such as, but not limited to, a Fourier transform or inverse Fourier transform. In this example, the two individual sequences A and B each have equal coherent processing interval durations T_{PA}=T_{PB}=T_{P}, with only the coherent processing interval T_{PA} for sequence A shown for clarity. Although the average frequency of both sequences A and B is shown to be the same in FIG. 9D, there may also be a shift in average frequency between sequences A and B. Also, the complex phase of each target spectral peak may be used for advantage in target data association and range-velocity ambiguity resolution. Furthermore, more than two sequences may be utilized, as well as more than one value of average frequency shift between sequences without departing from the spirit of the present invention.

FIG. 9E illustrates a stepped frequency modulation waveform for use in the Frequency Transmit Signal Generator 405 according to aspects of the present invention. This waveform comprises two intertwined, linearly stepped frequency sequences A and B, in which both sequences have an equal number of frequency steps N and equal frequencies for each step, but the start of sequence B is delayed from the start of sequence A by an amount □T_{D}. Also, the two sequences A and B each have equal coherent processing interval durations T_{PA}=T_{PB}=T_{P}, with only the coherent processing interval T_{PA} for sequence A shown for clarity. This waveform may repeat after a pre-determined number of steps in sequences A and B have been completed. Also, periods where the stepped frequency sequence is stopped may be inserted into the abovementioned patterns. In addition, the waveform shown in FIG. 9E is meant as an example, and is not meant as a limitation. One skilled in the art can modify the abovementioned waveform in a way such as using non-equal frequency step sizes, using more than two sequences, using sequences that have different step sizes from each other, using sequences that have different or opposite slopes, or using more than one value of □TD to obtain advantageous results for an application. Also, the time delay of sequence B may be such that the first segment of sequence B occurs after the second segment of sequence A, such as shown in FIG. 9F, or after a later segment of sequence A. Furthermore, to achieve high-resolution range radar performance, the total frequency modulation bandwidth, defined as B_{M} in FIG. 9E, can be ultra-wideband (UWB).

Using the type of stepped frequency waveform described in FIG. 9E, target information may be calculated from the digitized down-converted signals for the architectures shown in FIGS. 2A-B, FIG. 7, FIG. 11, FIG. 12, FIGS. 13A-H, and FIGS. 14A-C in the following manner. As an example, not meant in any way as a limitation, let the radar arrangement of FIG. 7 utilize the stepped frequency modulation waveform according to FIG. 9E. Let the down-converted signal be sampled once per each frequency step dwell time for each sequence A and B separately, and let the samples be associated with each sequence A and B separately for individual sequence signal processing, such as a complex FFT and spectral peak threshold detection. Detected peaks in the down-converted signal spectrum of each sequence represent target returns. Since both sequences A and B have the same slope, target spectral peaks for each sequence will occur at the same frequency or in the same FFT frequency bin. The frequency of the target peaks is ambiguous in target range and velocity, as shown in the following equation:
fⱼ=2·Rⱼ·□_{□}/(c·T_{P})+2·Vⱼ/□ (4)
where fⱼ is the measured frequency of the j^{th} peak in the spectrum of the down-converted difference signals, Rⱼ is range and Vⱼ is the relative velocity of the target corresponding to the j^{th} peak in the spectrum of the down-converted difference signals, B_{M} is the frequency modulation range over which the sequences A or B are modulated, c is the speed of light in a vacuum, T_{P} is the coherent processing time interval of sequence A or B, and □ is the average wavelength of sequence A or B.

By measuring the phase difference between the spectral peaks in the down-converted difference signals corresponding to the original and time-delayed sequences A and B that occur at the same frequency or in the same frequency bin of each Fourier transform, the target relative velocity can be directly determined for the waveform shown in FIG. 9E. The target's relative velocity can be determined using the following relation:
ΔΨⱼ=4·π·ΔT_{D}·Vⱼ/λ (5)
where ΔΨⱼ is the measured phase difference between the j^{th} peaks in the spectra of the down-converted difference signals corresponding to sequences A and B respectively, Vⱼ is the relative velocity of the target corresponding to the j^{th} peak in the spectrum of the down-converted difference signals, ΔT_{D} is the time delay of the start of sequence B from the start of sequence A, and λ is the average wavelength of sequence A or B. Thus, the jth target relative velocity Vⱼ can be solved for directly from the spectral peak phase difference measurement using equation (5), and used to solve for the jth target range Rⱼ from the spectral peak frequency measurement using equation (4). One benefit of using the waveform and method illustrated in FIG. 9E is that only a period of approximately T_{PA} is required to gather the measurement data required to determine target range and relative velocity even for multiple target situations, improving the update rate of the radar sensor as compared to using the waveforms illustrated in FIGS. 9A and 9B.

FIG. 9G illustrates a stepped frequency modulation waveform for use in the Stepped Frequency Transmit Signal Generator 405 according to aspects of the present invention. This waveform is comprised of multiple linearly stepped frequency waveform pairs intertwined. The individual stepped frequency waveform pairs can be, but are not limited to, the type as illustrated in FIG. 9E. In addition, the associated waveforms may be sets of more than two sequences each without departing from the present invention. Also, periods where the stepped frequency modulation pattern is stopped may be inserted into the abovementioned patterns. Furthermore, the order in which waveform patterns are intertwined can also be varied or randomized from coherent processing interval to coherent processing interval, which can be of benefit for interference reduction and/or channelization. In this example, one pair of linearly frequency stepped sequences A,B are intertwined with another pair of linearly frequency stepped sequences C,D. In this example, all the sequences A, B, C, and D each have equal coherent processing interval durations T_{PA}=T_{PB}=T_{PC}=T_{PD}=T_{P} with only the coherent processing interval T_{PA} for sequence A shown for clarity.

One benefit of using the waveform and method illustrated in FIG. 9G is that more frequency steps, and thus more spectral utilization and lower power spectral density per time period can be achieved for similar SNR if the target results for waveform pairs A,B and C,D are integrated, as compared to a single waveform pair A,B, which can be useful in transmit power limited situations such as for short-range radar sensing. In addition, the order in which waveforms are intertwined and/or the start times for the waveforms can be varied between subsequent coherent processing intervals. One benefit of such variation between subsequent coherent processing intervals can be to reduce potential interference or to provide an increased immunity to interference. Such parameters can be varied continuously and/or randomly after each coherent processing interval which may eliminate the need for interference detection, identification, and response circuitry.

FIG. 9H illustrates a stepped frequency modulation waveform for use in the Stepped Frequency Transmit Signal Generator 405 according to aspects of the present invention. The waveform of FIG. 9H consists of one or more linearly stepped frequency sequences where the order of the frequency steps of each sequence is randomized according to a predetermined order. Then, after reception, the A/D samples of the down-converted signal are correctly associated with each individual sequence and re-ordered to be in the original linear sequence prior to the application of at least one signal processing function such as, but not limited to, a Fourier transform or inverse Fourier transform. Under these conditions, the range can be calculated using the following equation:
Rⱼ=c·Tₛ·fⱼ/(2·□fₛ) (6)
where Rⱼ is the range of the j^{th} target, c is the speed of light in a vacuum, and where T_{S}, □f_{S}, and fⱼ are the frequency step dwell time, frequency step size, and j^{th} frequency peak in the down-converted signal spectrum, respectively, relating to the re-ordered sequence and measurements made on the re-ordered sequence. In addition, to achieve high-resolution range radar performance, the total frequency modulation bandwidth, defined as |f₂−f₁| in FIG. 6H, can be ultra-wideband (UWB) with a typical frequency modulation bandwidth such as, but not limited to, 1 GHz. Furthermore, the order in which waveforms are intertwined and/or the start times for the waveforms can be varied between subsequent coherent processing intervals. One benefit of such variation between subsequent coherent processing intervals can be to reduce potential interference or to provide an increased immunity to interference. Such parameters can be varied continuously and/or randomly after each coherent processing interval, which may eliminate the need for interference detection, identification, and response circuitry.

FIG. 10A illustrates one example of timing of receiver antenna selection for use with a linearly frequency stepped modulation waveform, compatible with the spatially separated signals processing methods according to aspects of the present invention. According to this example, the spatially separated receiver antennas RX 1 . . . RX n from FIG. 7 with n=8 are sequentially selected with respect to time. Each antenna is selected for a period of time denoted T_{DW}, during which the selected antenna is connected with the receiver/down-converter. During this period of time T_{DW}, an A/D sample is taken of the down-converted signal and stored. A typical value of T_{DW} can be within, but is not limited to, the range of 100 nanoseconds (ns)-100 microseconds (us). After all n receiver antennas are sequenced through, the sequence is repeated for the duration of the coherent processing time period T_{P} of the stepped frequency modulation waveform. The stored digital samples of the down-converted signals during this period T_{P} are grouped separately for each corresponding receiver antenna to create a sequence of time ordered samples of the down-converted signals for each receiver antenna spatial position, and will be used as part of the spatially separated signals processing methods. The sequence of antenna selection may be varied for subsequent coherent processing intervals for advantage provided that the stored digital samples are grouped separately for each corresponding receiver antenna. Furthermore, a subset of the antennas may be selected for advantage.

FIG. 10B illustrates an example of a down-converted target signal and A/D sample timing consistent with the stepped frequency modulation waveform and receiver antenna sequencing method described in FIG. 10A. The A/D sample values of the down-converted signal are illustrated by the black dots and are labeled Anⱼ, where n is an integer from 1 to 8 in this example representing the receiver antenna number RX n, and j is an integer from 1 to N−1 representing the A/D sample number within an N point sample sequence. For this example, let N=256 samples during one coherent processing time period T_{P}. As can be seen, each successive A/D sample is delayed in time with respect to the preceding A/D sample by a time equal to T_{DW}, and occurs at a different phase on the down-converted target signal. For spatially separated signals processing methods that utilize complex signal phase, it is advantageous to utilize digitized down-converted signals which have the difference in A/D sample timing between them compensated. Since the difference in sample timing between adjacently selected receiver antenna means is equal to a time delay T_{DW}, this can be compensated for in the complex frequency domain as a frequency-dependent phase shift. As an example, let each digitized sample sequence Anⱼ of the down-converted signals during the period T_{P} be grouped separately for each corresponding receiver antenna and ordered in time. Let each separate sequence corresponding to each receiver antenna be processed separately by an N-point complex FFT. The difference in sample timing between each receiver antenna FFT sequence can be compensated by applying the phase shift in the following equation to the complex frequency points in the FFT sequence:
ΔΨ=2·π·fⱼ·ΔTₖ (7)
where fⱼ is the frequency of the jth position in the FFT sequence, j is an integer between 1 and N−1 for an N-point FFT sequence, and □Tₖ is the difference in time between the sample time of receiver antenna 1 and the k^{th} receiver antenna in the receiver antenna selection sequence.

FIG. 10C illustrates another example of timing of receiver antenna selection for use with a linearly frequency stepped modulation waveform, compatible with the spatially separated signals processing methods according to aspects of the present invention. This example is similar to that illustrated in FIG. 10A with the exception that the order of selection of the receive antennas can be modified to any predetermined order. Furthermore, a subset of the antennas may be selected for advantage.

FIG. 10D illustrates a further example of timing of receiver antenna selection for use with intertwined linearly frequency stepped modulation waveforms, compatible with the spatially separated signals processing methods according to aspects of the present invention. This example is similar to the example illustrated in FIG. 10A with the exception that two frequency steps occur during the time each receive antenna is selected, one step from sequence A and the other step from sequence B. During each frequency step for each sequence A and B, an A/D sample is taken of the down-converted signal and stored. After all n receiver antennas are sequenced through, the sequence is repeated for the duration of the coherent processing time period of the intertwined stepped frequency modulation waveform. The stored digital samples of the down-converted signals during this period are grouped separately for each corresponding receiver antenna and for each sequence A and B to create a sequence of time ordered samples of the down-converted signals for each receiver antenna spatial position for each sequence separately.

FIG. 10E illustrates a yet further example of timing of receiver antenna selection for use with a linearly frequency stepped modulation waveform, compatible with the spatially separated signals processing methods according to aspects of the present invention. In this example, a set of 8 receive antennas are grouped into two parallel groups of four each, with each group of four being sequentially selected from to feed two parallel receiver/down-converters, such as illustrated in FIG. 11 with m=4 and n=8. During each frequency step, an A/D sample for each of the two selected antennas is taken of the down-converted signals and stored. After all n receiver antennas are sequenced through, the sequence is repeated for the duration of the coherent processing time period of the stepped frequency modulation waveform. The stored digital samples of the down-converted signals during this period are grouped separately for each corresponding receiver antenna to create a sequence of time ordered samples of the down-converted signals for each receiver antenna spatial position separately, and will be used as part of the spatially separated signals processing methods.

According to one aspect of the present invention, the spatial FFT method is presented as a method of spatially separated signals processing. The spatial FFT method is adapted for use with the architectures illustrated in FIG. 7, FIG. 11, FIG. 12, and FIGS. 13A-H, utilizing the digitized FFT sequences from each of the n spatially separated receiver antenna means, utilizing the digitized FFT sequences from each of the n·m synthesized receiver array antenna positions such as for FIGS. 2A-B, or utilizing the digitized FFT sequences from each of the n·k synthesized receiver array antenna positions such as for FIGS. 14A-C. An advantage of spatial FFT processing is that only one set of FFT sequences needs to be obtained for each of the spatially separated receiver antenna positions. In this method, an n-point spatial FFT is performed on the data from each range bin of the complex FFT data sets for the antenna elements in the n-element receiver array. The n outputs from the spatial FFT data for each range bin indicate different fixed receive array directional gain patterns, or detection zones, across the field-of-view. By analyzing the detected power of target returns in each of the n outputs, which each represent a different angular direction within the field-of-view, target direction can be determined. Spatial processing methods that require only one set of FFT sequences to be obtained for each of the spatially separated receiver antenna positions can be advantageous for automotive short-range radar (SRR) applications where target threat update rate requirements can be on the same order as a coherent processing period T_{P} due to Doppler velocity resolution requirements. For example, the target threat list may be required to update every 8 ms for automotive pre-crash applications, and simultaneously a target's velocity resolution requirement may require an 8 ms coherent processing period T_{P} while also providing target azimuth direction finding capability. For these applications, the ability to collect all the data required for spatial processing in a single coherent processing interval can be useful, especially when utilizing intertwined frequency-stepped waveforms such as those described in FIGS. 9C-G which provide the necessary information to resolve target range-velocity ambiguities in approximately a single coherent processing interval.

According to another aspect of the present invention, the digital beam-forming (DBF) method is presented as another method of spatially separated signals processing. The digital beam-forming method is adapted for use with the architectures illustrated in FIG. 7, FIG. 11, FIG. 12, and FIGS. 13A-H, utilizing the digitized fast Fourier transformed (FFT) sequences from each of the n spatially separated receiver antenna means, utilizing the digitized FFT sequences from each of the n-m synthesized receiver array antenna positions such as for FIGS. 2A-B, or utilizing the digitized FFT sequences from each of the n·k synthesized receiver array antenna positions such as for FIGS. 14A-C. The digital beam-forming method has the advantage that once a set of FFT sequences is obtained for each of the spatially separated receiver antenna positions, a multitude of receiver array gain patterns can be synthesized from the same set of data, and target range and relative velocity can be determined from the Fourier transform profiles calculated for each. One method of digital beam-forming signal processing is to synthesize receiver beam-patterns, or receive antenna array gain patterns, through combining of digitally phase shifted or digitally phase shifted and amplitude scaled complex FFT data from each antenna spatial position. One method of determining the direction of a target is through scanning of receiver beam patterns across the field-of-view, where the angular direction of a target is determined through detection of the beam direction where the maximum power return occurs for a target.

According to a further aspect of the present invention, the digital multi-zone monopulse is (DMM) method is presented as a further method of spatially separated signals processing. The digital multi-zone monopulse method is adapted for use with the architectures illustrated in FIG. 7, FIG. 11, FIG. 12, and FIGS. 13A-H, utilizing the digitized FFT sequences from each of the n spatially separated receiver antenna means, utilizing the digitized FFT sequences from each of the n-m synthesized receiver array antenna positions such as for FIGS. 2A-B, or utilizing the digitized FFT sequences from each of the n·k synthesized receiver array antenna positions such as for FIGS. 14A-C. An advantage of digital multi-zone monopulse (DMM) processing is that only one set of FFT sequences needs to be obtained for each of the spatially separated receiver antenna positions. In this method, a set of fixed, directional, adjacent receiver antenna array gain patterns is formed using either the spatial FFT method or the digital beam-forming method previously described. One example of fixed, adjacent receive antenna array gain patterns, not meant as a limitation, is shown in FIG. 10F. In the regions between adjacent receive detection zones, denoted by regions A-E in FIG. 10F, comparison of target amplitude in adjacent detection zones or the amplitude monopulse direction finding method can be utilized to determine fine target direction. In this way, fine target direction can be determined over a wide field-of-view with angular target resolution capability and a potentially fast update rate, with lower processing load as compared to the scanned-beam digital beam-forming direction finding method previously described.

According to a yet further aspect of the present invention, the super-resolution processing method is presented as another method of spatially separated signals processing. The super-resolution processing method is adapted for use with the architectures illustrated in FIG. 7, FIG. 11, FIG. 12, and FIGS. 13A-H, utilizing the digitized FFT sequences from each of the n spatially separated receiver antenna means, utilizing the digitized FFT sequences from each of the n·m synthesized receiver array antenna positions such as for FIGS. 2A-B, or utilizing the digitized FFT sequences from each of the n·k synthesized receiver array antenna positions such as for FIGS. 14A-C. An advantage of the super-resolution processing method is that only one set of FFT sequences needs to be obtained for each of the spatially separated receiver antenna positions. In this method, a super-resolution algorithm is used to process the complex phase of the spatially separated signals to determine the direction of one or a plurality of targets within the field-of-view. The basic relation of the phase difference between spatially separated receive antennas and target angular direction can be expressed by the following equation:
θⱼ=arc sin [ΔΨ_{j,m,n}·λ/(2·π·D_{m,n})] (8)
where θⱼ is the direction from boresight of the j^{th} target return, ΔΨ_{j,m,n} is the phase difference corresponding to the j^{th} target return between receive antenna positions m and n, D is the distance separating receive antenna positions m and n in the axis in which target direction θ is to be determined, λ is the average received wavelength of the stepped frequency modulated radar waveform during a coherent measurement interval, k is an integer greater than or equal to 2, m is an integer greater than 1 and less than or equal to k+1, and n is an integer greater than 0 and less than or equal to k. Since phase differences between receive antenna positions is preserved after down-conversion, the phase differences between the down-converted difference signals corresponding to the receive antenna positions can be used for ΔΨ. The set of phase measurements between a plurality of spatially separated receive antenna positions can be used as inputs to a super-resolution algorithm, which outputs the maximum likelihood of target angular positions based upon the set of input data. Furthermore, a super-resolution algorithm has the ability to provide target angular resolution within the field-of-view of the receive antennas. One such super-resolution algorithm known in the art is the multiple signal classification algorithm (MUSIC). Another such super-resolution algorithm known in the art is the estimation of signal parameters via rotational invariance techniques (ESPRIT).

A radar sensor arrangement is presented in FIG. 11 as another embodiment of aspects of the present invention. The arrangement in FIG. 11 is similar to the arrangement in FIG. 7 except for the use of a plurality of receiver antenna selection switches 14, 16 and the use of a plurality of parallel receiver/down-converter paths for the radar sensor. The same components are denoted by the same reference numerals, and will not be explained again. The reflected signal from a target will be received by an array of n receiver antennas 121, 171, 151, 141 designated by RX 1, RX m, RX m+1, and RX n, where m is an integer greater than or equal to 2, and n is an integer greater than or equal to 4. The n receiver antennas are arrayed and spatially separated from each other in each axis in which target angular direction is to be determined. A selection switch 14 is used to selectively connect one receiver antenna at a time from receiver antenna group RX 1 . . . RX m with a first receiver/down-converter for the radar sensor in a sequential manner controlled by RX_SEL_A, and a selection switch 16 is used to selectively connect one receiver antenna at a time from receiver antenna group RX m+1 . . . . RX n with a second receiver/down-converter for the radar sensor in a sequential manner controlled by RX_SEL_B. The first receiver/down-converter for the radar sensor contains a low noise amplifier 62 where the received signal is amplified prior to being input to down-converting mixer 55, where the signal is mixed with one output signal from signal splitter 28, and the resulting signal is amplified by amplifier 65 and filtered by filter 45. After filtering by filter 45, the resulting signal is then digitized by analog-to-digital converter 340 and input to a signal processor 300for signal processing. The second receiver/down-converter for the radar sensor contains a low noise amplifier 63 where the received signal is amplified prior to being input to down-converting mixer 56, where the signal is mixed with one output signal from signal splitter 28, and the resulting signal is amplified by amplifier 66 and filtered by filter 46. After filtering by filter 46, the resulting signal is then digitized by analog-to-digital converter 341 and input to a signal processor 300 for signal processing. During the dwell time for each receiver antenna in the receiver array, the signal segment corresponding to that antenna position is digitized and stored for use as part of a spatially separated signals processing method. Through the use of a plurality of receiver antenna groups and receiver selection switches, and parallel receiver/down-converters, the signal-to-noise-ratio (SNR) of the detected target returns can be improved in comparison with using only one receiver/down-converter. This can be important for automotive short-range radar (SRR) sensor collision warning or collision avoidance applications where a fast update rate of a target threat list and high target SNR are typically simultaneously required.

The block diagram shown in FIG. 11 can be modified according to aspects of the present invention. One example of such a modification, not meant as a limitation, can be to replace mixers 55, 56 with I/Q complex mixers for complex signal down-conversion and to modify the block diagram accordingly. Another example of such a modification, not meant as a limitation, can be for the radar sensor architecture to remove the antenna selection switches and connect each of the parallel receiver/down-converter channels directly with the corresponding antenna elements in the RX array, utilizing for example, but not limited to, 4, 8, or 16 parallel receiver/down-converter channels. A further example of such a modification, not meant as a limitation, can be for the radar sensor architecture to replace the selection switches 14, 16 with a plurality of switched amplifiers and signal combiners, utilizing the gain/loss of the switched amplifiers to realize an antenna selection and routing function. A yet further example of such a modification, not meant as a limitation, can be for the radar sensor architecture to use remote signal processing, remote analog-to-digital (A/D) conversion, or shared processing and/or shared AID conversion. Another example of such a modification, not meant as a limitation, can be for the radar sensor architecture to share an RX antenna with the TX antenna function, or to utilize a plurality of switched TX antennas in combination with the switched RX antennas to synthesize a receive antenna array. Mixers 55, 56 can be implemented by, but are not limited to, mixers, multipliers, or switches without changing the basic functionality of the arrangement. Filters 45, 46 can be implemented by, but are not limited to, low-pass filters or band-pass filters. Signal splitters 27, 28 can be implemented by, but are not limited to, Wilkinson power dividers, passive splitter, active splitter, or microwave coupler. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to the described arrangement, or the position of existing elements may be modified, without changing the basic form or spirit of the invention.

A radar sensor arrangement is presented in FIG. 12 as a further embodiment of aspects of the present invention. The arrangement in FIG. 12 is similar to the arrangement in FIG. 7 except for the use of a transmit-receive (T/R) modulator 80 which is used to control a transmit gating switch 75 and a receiver gating switch 15. A typical frequency used for the T/R modulator 80 can be within, but is not limited to, the frequency range 100 KHz-10 MHz. The same components are denoted by the same reference numerals, and will not be explained again. A transmit-receive (T/R) modulator 80 is connected to a transmit gating switch 75 which has the purpose of gating the transmit signal prior to transmission. The signal from the transmit-receive (T/R) modulator 80 is also connected to an inverter 22 prior to controlling a receiver gating switch 15. In this arrangement, the transmit signal is gated off when the receive signal is gated on, and vice versa, with a timing dictated by the T/R modulator 80. The receiver gating switch 15 can be placed before the LNA 62 or combined with the antenna selection switch 12 without departing from the spirit of the present invention. Through the use of this arrangement of transmitter and receiver gating, receiver saturation due to signal coupling with the transmitter can be reduced or eliminated, and strong returns from nearby targets can be attenuated improving dynamic range.

The block diagram shown in FIG. 12 can be modified according to aspects of the present invention. One example of such a modification, not meant as a limitation, can be to replace mixer 55 with an I/Q complex mixer for complex signal down-conversion and modify the block diagram accordingly. Another example of such a modification, not meant as a limitation, can be for the radar sensor architecture to include a plurality of antenna selection switches and receiver/down-converter channels such as described in FIG. 11. A further example of such a modification, not meant as a limitation, can be for the radar sensor architecture to replace the selection switch 12 with a plurality of switched amplifiers and signal combiners, utilizing the gain/loss of the switched amplifiers to realize an antenna selection and routing function. A yet further example of such a modification, not meant as a limitation, can be for the radar sensor architecture to use remote signal processing, remote analog-to-digital (A/D) conversion, or shared processing and/or shared A/D conversion. Another example of such a modification, not meant as a limitation, can be for the radar sensor architecture to share an RX antenna with the TX antenna function, or to utilize a plurality of switched TX antennas in combination with the switched RX antennas to synthesize a receive antenna array. Mixer 55 can be implemented by, but is not limited to, a mixer, multiplier, or switch without changing the basic functionality of the arrangement. Filter 48 can be implemented by, but is not limited to, a low-pass filter or band-pass filter. Transmit gating switch 75 and receiver gating switch 15 can be implemented by, but are not limited to, switches or modulators. The receiver gating switch functionality can also be implemented by switching on and off the LNA 62, creating signal isolation from the LNA's input to its output during the off state without departing from the present invention. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to the described arrangement, or the position of existing elements may be modified, without changing the basic form or spirit of the invention.

A radar sensor arrangement is presented in FIG. 13A as a yet further embodiment of aspects of the present invention. The arrangement in FIG. 13A is similar to the arrangement in FIG. 12, except for the addition of an intermediate frequency (IF) modulator 70 and associated circuitry, and additional down-conversion circuitry used to create in-phase (I) and quadrature (Q) signals prior to signal A/D conversion. The same components are denoted by the same reference numerals, and will not be explained again. A transmit-receive (T/R) modulator 80 is connected to an inverter 22 and the resulting signal is connected to one input of an AND gate 80. The other input of AND gate 80 is connected to an intermediate frequency (IF) modulator 70. A typical frequency used for the IF modulator 70 can be within, but is not limited to, the frequency range of 1 MHz-100 MHz. The output of AND gate 80 is connected to the receiver gating switch 15, which has the purpose of both gating the received signal and providing modulation of the received signal by the frequency of the IF modulator 70 prior to the received signal entering the mixer 55. The signal from the transmit-receive (T/R) modulator 80 is also connected to a transmit gating switch 75 which has the purpose of gating the transmit signal prior to transmission. The mixer 55 provides down-conversion of the received signal to an IF signal frequency. The resulting signal is then input to a filter 39, and the resulting signal is then split and fed to mixer 86 which mixes the signal with the output from the IF modulator 70, and mixer 85 which mixes the signal with the output from the IF modulator 70 shifted in phase by 90 degrees using 90 degree phase shifter 77, creating I and Q down-converted signals. The I and Q down-converted signals are then filtered by filters 35, 36 prior to sampling by A/D converters 340, 350. The resulting sampled I and Q signals are then input to signal processor 300for signal processing. To more clearly illustrate functionality, amplifiers have been omitted from the radar architecture illustrated in FIG. 13A. Through the use of this arrangement of transmitter and receiver gating and intermediate frequency conversion, receiver saturation due to signal coupling with the transmitter can be reduced or eliminated, strong returns from nearby targets can be attenuated improving dynamic range, and noise associated with the down-conversion process can be improved.

The block diagram shown in FIG. 13A can be modified according to aspects of the present invention. One example of such a modification, not meant as a limitation, can be for the radar sensor architecture to include a plurality of antenna selection switches and receiver/down-converter channels such as described in FIG. 11. Another example of such a modification, not meant as a limitation, can be for the radar sensor architecture to replace the selection switch 12 with a plurality of switched amplifiers and signal combiners, utilizing the gain/loss of the switched amplifiers to realize an antenna selection and routing function. A further example of such a modification, not meant as a limitation, can be for the radar sensor architecture to use remote signal processing, remote analog-to-digital (A/D) conversion, or shared processing and/or shared A/D conversion. A yet further example of such a modification, not meant as a limitation, can be for the radar sensor architecture to share an RX antenna with the TX antenna function, or to utilize a plurality of switched TX antennas in combination with the switched RX antennas to synthesize a receive antenna array. Another example of such a modification, not meant as a limitation, can be for the radar sensor architecture to use an A/D converter to sample the intermediate frequency signal after the filter 39 and perform the second down-conversion digitally. Mixer 55 can be implemented by, but is not limited to, a mixer, multiplier, or switch without changing the basic functionality of the arrangement. Filter 39 can be implemented by, but is not limited to, a band-pass filter. Filters 35, 36 can be implemented by, but are not limited to, low-pass filters. Transmit gating switch 75 and receiver gating switch 15 can be implemented by, but are not limited to, switches or modulators. The receiver gating switch can also be implemented by switching on and off a low noise amplifier (LNA) in place of receiver gating switch 15, creating signal isolation from the LNA's input to its output during the off state without departing from the present invention. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to the described arrangement, or the position of existing elements may be modified, without changing the basic form or spirit of the invention.

A radar sensor arrangement is presented in FIG. 13B as another embodiment of the present invention. The arrangement in FIG. 13B is similar to the arrangement in FIG. 13A except for the use of a plurality of receiver antenna selection switches 14, 16 and the use of a plurality of parallel receiver/down-converter paths for the radar sensor. The same components are denoted by the same reference numerals, and will not be explained again. The reflected signal from a target will be received by an array of n receiver antennas 121, 171, 151, 141 designated by RX 1, RX m, RX m+1, and RX n, where m is an integer greater than or equal to 2, and n is an integer greater than or equal to 4. The n receiver antennas are arrayed and spatially separated from each other in each axis in which target angular direction is to be determined. A selection switch 14 is used to selectively connect one receiver antenna at a time from receiver antenna group RX 1 . . . RX m with a first receiver/down-converter for the radar sensor in a sequential manner, and a selection switch 16 is used to selectively connect one receiver antenna at a time from receiver antenna group RX m+1 . . . RX n with a second receiver/down-converter for the radar sensor in a sequential manner. The first selection switch is controlled by a signal designated as RX_SEL_A, while the selection switch is controlled by a signal designated as RX_SEL_B. The signals RX_SEL_A and RX_SEL_B can be the same without departing from the spirit of the present invention. The first receiver/down-converter for the radar sensor contains a receiver gating switch 15 where the received signal is gated prior to being input to down-converting mixer 55. The remaining functionality of the first receiver/down-converter is similar to that described in FIG. 13A and will not be explained again. The second receiver/down-converter for the radar sensor contains a receiver gating switch 15a where the received signal is gated prior to being input to down-converting mixer 55a, where the signal is mixed with one output signal from signal splitter 28, and the resulting signal is filtered by filter 39a. After filtering by filter 39a, the resulting signal is then split and fed to mixer 86a which mixes the signal with the output from the IF modulator 70a, and mixer 85a which mixes the signal with the output from the IF modulator 70 shifted in phase by 90 degrees using 90 degree phase shifter 77a, creating I and Q down-converted signals. The I and Q down-converted signals are then filtered by filters 35a, 36a prior to sampling by A/D converters 340a, 350a. The resulting sampled I and Q signals are then input to signal processor 300 for signal processing. During the dwell time for each receiver antenna in the receiver array, the signal segment corresponding to that antenna position is digitized and stored for use as part of a spatially separated signals processing method. Through the use of a plurality of receiver antenna groups and receiver selection switches, and parallel receiver/down-converters, the signal-to-noise-ratio (SNR) of the detected target returns can be improved in comparison with using only one receiver/down-converter. This can be important for automotive short-range radar (SRR) sensor collision warning or collision avoidance applications where a fast update rate of a target threat list and high target SNR are typically simultaneously required.

The block diagram shown in FIG. 13B can be modified according to aspects of the present invention. One example of such a modification, not meant as a limitation, can be for the radar sensor architecture to include a plurality of antenna selection switches and receiver/down-converter channels, such as, but not limited to, 4, 8, or 16 antenna selection switches and receiver/down-converter channels. Another example of such a modification, not meant as a limitation, can be for the radar sensor architecture to remove the antenna selection switches and connect each of the parallel receiver/down-converter channels directly with the corresponding antenna elements in the RX array, utilizing for example, but not limited to, 4, 8, or 16 parallel receiver/down-converter channels. A further example of such a modification, not meant as a limitation, can be for the radar sensor architecture to replace the selection switches 14, 16 with a plurality of switched amplifiers and signal combiners, utilizing the gain/loss of the switched amplifiers to realize an antenna selection and routing function. A yet further example of such a modification, not meant as a limitation, can be for the radar sensor architecture to share an RX antenna with the TX antenna function, or to utilize a plurality of switched TX antennas in combination with the switched RX antennas to synthesize a receive antenna array. Another example of such a modification, not meant as a limitation, can be for the radar sensor architecture to use remote signal processing, remote analog-to-digital (A/D) conversion, or shared processing and/or shared A/D conversion. A further example of such a modification, not meant as a limitation, can be for the radar sensor architecture to use AID converters to sample the intermediate frequency signal after the filters 39, 39a and perform the second down-conversion digitally. Mixers 55, 55a can be implemented by, but are not limited to, mixers, multipliers, or switches without changing the basic functionality of the arrangement. Filters 39, 39a can be implemented by, but are not limited to, band-pass filters. Filters 35, 36, 35a, 36a can be implemented by, but are not limited to, low-pass filters. Receiver gating switches 15, 15a can be implemented by, but are not limited to, switches or modulators. The receiver gating switch can also be implemented by switching on and off a low noise amplifier (LNA) in place of receiver gating switches 15, 15a, creating signal isolation from the LNA's input to its output during the off state without departing from the present invention. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to the described arrangement, or the position of existing elements may be modified, without changing the basic form or spirit of the invention.

A radar sensor arrangement is presented in FIG. 13C as a further embodiment of the present invention. The arrangement in FIG. 13C is similar to the arrangement in FIG. 13A, except for the removal of an intermediate frequency (IF) modulator 70, removal of AND gate 43, and re-positioning of inverter 22. The same components are denoted by the same reference numerals, and will not be explained again. In this configuration, the T/R modulation frequency is used to control the transmit gating switch 75 and receive gating switch 15, as well for up-conversion of the received signal prior to entering mixer 55. The output of mixer 55 will be an intermediate frequency signal at the T/R modulation frequency. After filtering by filter 39, the resulting signal is then split and fed to mixer 85 which mixes the signal with the output from the transmit-receive (T/R) modulator 80, and mixer 86 which mixes the signal with the output from the transmit-receive (T/R) modulator 80 shifted in phase by 90 degrees using 90 degree phase shifter 77, creating I and Q down-converted signals. The I and Q down-converted signals are then filtered by filters 35, 36 prior to sampling by A/D converters 340, 350. The resulting sampled I and Q signals are then input to signal processor 300 for signal processing. To more clearly illustrate functionality, amplifiers have been omitted from the radar architecture illustrated in FIG. 13C. Through the use of this arrangement of transmitter and receiver gating and intermediate frequency conversion, receiver saturation due to signal coupling with the transmitter can be reduced or eliminated, strong returns from nearby targets can be attenuated improving dynamic range, and noise associated with the down-conversion process can be improved.

The block diagram shown in FIG. 13C can be modified according to aspects of the present invention. One example of such a modification, not meant as a limitation, can be for the radar sensor architecture to include a plurality of antenna selection switches and receiver/down-converter channels such as described in FIG. 11. Another example of such a modification, not meant as a limitation, can be for the radar sensor architecture to replace the selection switch 12 with a plurality of switched amplifiers and signal combiners, utilizing the gain/loss of the switched amplifiers to realize an antenna selection and routing function. A further example of such a modification, not meant as a limitation, can be for the radar sensor architecture to use remote signal processing, remote analog-to-digital (A/D) conversion, or shared processing and/or shared A/D conversion. A yet further example of such a modification, not meant as a limitation, can be for the radar sensor architecture to share an RX antenna with the TX antenna function, or to utilize a plurality of switched TX antennas in combination with the switched RX antennas to synthesize a receive antenna array. Another example of such a modification, not meant as a lo limitation, can be for the radar sensor architecture to use an AID converter to sample the intermediate frequency signal after the filter 39 and perform the second down-conversion digitally. Mixer 55 can be implemented by, but is not limited to, a mixer, multiplier, or switch without changing the basic functionality of the arrangement. Filter 39 can be implemented by, but is not limited to, a band-pass filter or low-pass filter. Filters 35, 36 can be implemented by, but are not limited to, low-pass filters. Transmit gating switch 75 and receiver gating switch 15 can be implemented by, but are not limited to, switches or modulators. The receiver gating switch can also be implemented by switching on and off a low noise amplifier (LNA) in place of receiver gating switch 15, creating signal isolation from the LNA's input to its output during the off state without departing from the present invention. Filter 39 can also be removed from the arrangement without departing from the spirit of the present invention. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to the described arrangement, or the position of existing elements may be modified, without changing the basic form or spirit of the invention.

A radar sensor arrangement is presented in FIG. 13D as a yet further embodiment of the present invention. The arrangement in FIG. 13D is similar to the arrangement in FIG. 13A, except for the removal of the T/R modulator 80 and associated T/R modulation circuitry such as inverter 22, AND gate 43, and receiver gating circuit 15. The same components are denoted by the same reference numerals, and will not be explained again. In this configuration, the IF modulation frequency of IF modulator 70 is used to control the transmit gating switch 75, as well for the second down-conversion operation with mixers 85, 86. To more clearly illustrate functionality, amplifiers have been omitted from the radar architecture illustrated in FIG. 13D. Through the use of this arrangement of transmit signal gating by the IF modulation frequency and two stage down-conversion, noise associated with the down-conversion process can be improved.

The block diagram shown in FIG. 13D can be modified according to aspects of the present invention. One example of such a modification, not meant as a limitation, can be for the radar sensor architecture to include a plurality of antenna selection switches and receiver/down-converter channels such as described in FIG. 11. Another example of such a modification, not meant as a limitation, can be for the radar sensor architecture to replace the selection switch 12 with a plurality of switched amplifiers and signal combiners, utilizing the gain/loss of the switched amplifiers to realize an antenna selection and routing function. A further example of such a modification, not meant as a limitation, can be for the radar sensor architecture to use remote signal processing, remote analog-to-digital (A/D) conversion, or shared processing and/or shared A/D conversion. A yet further example of such a modification, not meant as a limitation, can be for the radar sensor architecture to share an RX antenna with the TX antenna function, or to utilize a plurality of switched TX antennas in combination with the switched RX antennas to synthesize a receive antenna array. Another example of such a modification, not meant as a limitation, can be for the radar sensor architecture to use an A/D converter to sample the intermediate frequency signal after the filter 39 and perform the second down-conversion digitally. Mixer 55 can be implemented by, but is not limited to, a mixer, multiplier, or switch without changing the basic functionality of the arrangement. Filter 39 can be implemented by, but is not limited to, a band-pass filter or low-pass filter. Filters 35, 36 can be implemented by, but are not limited to, low-pass filters. Transmit gating switch 75 can be implemented by, but is not limited to, a switch, modulator, or bi-phase modulator. Filter 39 can also be removed from the arrangement without departing from the spirit of the present invention. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to the described arrangement, or the position of existing elements may be modified, without changing the basic form or spirit of the invention.

A radar sensor arrangement is presented in FIG. 13E as another embodiment of the present invention. The arrangement in FIG. 13E is similar to the arrangement in FIG. 13C, except for the addition of receive gating switch 15, and the addition of a separate transmit pulse control signal. The same components are denoted by the same reference numerals, and will not be explained again. In this configuration, the TX PULSE CONTROL signal is used to control the transmit gating switch 75, pulse modulating the output signal. The IF modulation frequency of IF modulator 70 is used to control the receive gating switch 15, which creates an intermediate frequency signal offset, as well for the second down-conversion operation with mixers 85, 86. To more clearly illustrate functionality, amplifiers have been omitted from the radar architecture illustrated in FIG. 13E. Through the use of this arrangement of transmit pulsing, receive signal gating by the IF modulation frequency, and two stage down-conversion, the instantaneous bandwidth of the transmit signal can be increased, and noise associated with the down-conversion process can be improved.

The block diagram shown in FIG. 13E can be modified according to aspects of the present invention. One example of such a modification, not meant as a limitation, can be for the radar sensor architecture to include a plurality of antenna selection switches and receiver/down-converter channels such as described in FIG. 11. Another example of such a modification, not meant as a limitation, can be for the radar sensor architecture to replace the selection switch 12 with a plurality of switched amplifiers and signal combiners, utilizing the gain/loss of the switched amplifiers to realize an antenna selection and routing function. A further example of such a modification, not meant as a limitation, can be for the radar sensor architecture to use remote signal processing, remote analog-to-digital (A/D) conversion, or shared processing and/or shared A/D conversion. A yet further example of such a modification, not meant as a limitation, can be for the radar sensor architecture to share an RX antenna with the TX antenna function, or to utilize a plurality of switched TX antennas in combination with the switched RX antennas to synthesize a receive antenna array. Another example of such a modification, not meant as a limitation, can be for the radar sensor architecture to use an A/D converter to sample the intermediate frequency signal after the filter 39 and perform the second down-conversion digitally. Mixer 55 can be implemented by, but is not limited to, a mixer, multiplier, or switch without changing the basic functionality of the arrangement. Filter 39 can be implemented by, but is not limited to, a band-pass filter or low-pass filter. Filters 35, 36 can be implemented by, but are not limited to, low-pass filters. Transmit gating switch 75 can be implemented by, but is not limited to, a switch or modulator. Receive gating switch 15 can be implemented by, but is not limited to, a switch, modulator, or bi-phase modulator. Filter 39 can also be removed from the arrangement without departing from the spirit of the present invention. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to the described arrangement, or the position of existing elements may be modified, without changing the basic form or spirit of the invention.

A radar sensor arrangement is presented in FIG. 13F as another embodiment of the present invention. The arrangement in FIG. 13F is similar to the arrangement in FIG. 13E, except for the removal of receive gating switch 15, and the addition of local oscillator modulator 96. The same components are denoted by the same reference numerals, and will not be explained again. In this configuration, the TX PULSE CONTROL signal is used to control the transmit gating switch 75, pulse modulating the output signal. The IF modulation frequency of IF modulator 70 is used to control the local oscillator modulator 96 creating an intermediate frequency offset signal from the local oscillator frequency which is input to mixer 55 to mix with the received signal. The result is the creation of intermediate frequency signal components after the mixer 55. The output signal from mixer 55 is then down-converted to the baseband I/Q signals using mixers 85, 86. To more clearly illustrate functionality, amplifiers have been omitted from the radar architecture illustrated in FIG. 13F. Through the use of this arrangement of transmit pulsing, local oscillator signal modulation by the IF modulation frequency, and two stage down-conversion, the instantaneous bandwidth of the transmit signal can be increased, and noise associated with the down-conversion process can be improved.

The block diagram shown in FIG. 13F can be modified according to aspects of the present invention. One example of such a modification, not meant as a limitation, can be for the radar sensor architecture to include a plurality of antenna selection switches and receiver/down-converter channels such as described in FIG. 11. Another example of such a modification, not meant as a limitation, can be for the radar sensor architecture to replace the selection switch 12 with a plurality of switched amplifiers and signal combiners, utilizing the gain/loss of the switched amplifiers to realize an antenna selection and routing function. A further example of such a modification, not meant as a limitation, can be for the radar sensor architecture to use remote signal processing, remote analog-to-digital (A/D) conversion, or shared processing and/or shared A/D conversion. A yet further example of such a modification, not meant as a limitation, can be for the radar sensor architecture to share an RX antenna with the TX antenna function, or to utilize a plurality of switched TX antennas in combination with the switched RX antennas to synthesize a receive antenna array. Another example of such a modification, not meant as a limitation, can be for the radar sensor architecture to use an AID converter to sample the intermediate frequency signal after the filter 39 and perform the second down-conversion digitally. Mixer 55 can be implemented by, but is not limited to, a mixer, multiplier, or switch without changing the basic functionality of the arrangement. Filter 39 can be implemented by, but is not limited to, a band-pass filter or low-pass filter. Filters 35, 36 can be implemented by, but are not limited to, low-pass filters. Transmit gating switch 75 can be implemented by, but is not limited to, a switch or modulator. Local oscillator modulator 96 can be implemented by, but is not limited to, a switch, modulator, or bi-phase modulator. Filter 39 can also be removed from the arrangement without departing from the spirit of the present invention. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to the described arrangement, or the position of existing elements may be modified, without changing the basic form or spirit of the invention.

A radar sensor arrangement is presented in FIG. 13G as another embodiment of the present invention. The arrangement in FIG. 13G is one example of a combination of the concepts of transmit pulsing and IF modulation of the local oscillator signal described in FIG. 13F with the multiple receive antenna selection groups and multiple receive channels described in FIG. 13B. The same components are denoted by the same reference numerals, and will not be explained again. In this configuration, the TX PULSE CONTROL signal is used to control the transmit gating switch 75, pulse modulating the output signal. Through the use of this arrangement of transmit pulsing, local oscillator signal modulation by the IF modulation frequency, two stage down-conversion, and multiple receive antenna selection groups, the instantaneous bandwidth of the transmit signal can be increased, the noise associated with the down-conversion process can be improved, and the SNR can be increased. This arrangement is an example of how concepts illustrated in plurality of previously described radar sensor architectures can be combined with the resulting radar sensor architecture according to aspects of the present invention.

The block diagram shown in FIG. 13G can be modified according to aspects of the present invention. One example of such a modification, not meant as a limitation, can be for the radar sensor architecture to replace the selection switches 14, 16 with a plurality of switched amplifiers and signal combiners, utilizing the gain/loss of the switched amplifiers to realize an antenna selection and routing function. Another example of such a modification, not meant as a limitation, can be for the radar sensor architecture to use remote signal processing, remote analog-to-digital (A/D) conversion, or shared processing and/or shared A/D conversion. A further example of such a modification, not meant as a limitation, can be for the radar sensor architecture to share an RX antenna with the TX antenna function, or to utilize a plurality of switched TX antennas in combination with the switched RX antennas to synthesize a receive antenna array. Another example of such a modification, not meant as a limitation, can be for the radar sensor architecture to use an A/D converter to sample the intermediate frequency signal after the filter 39 and perform the second down-conversion digitally. Mixers 55, 55a can be implemented by, but are not limited to, mixers, multipliers, or switches without changing the basic functionality of the arrangement. Filters 39, 39a can be implemented by, but are not limited to, band-pass filters or low-pass filters. Filters 35, 36, 35a, 36a can be implemented by, but are not limited to, low-pass filters. Transmit gating switch 75 can be implemented by, but is not limited to, a switch or modulator. Local oscillator modulator 96 can be implemented by, but is not limited to, a switch, modulator, or bi-phase modulator. Filters 39, 39a can also be removed from the arrangement without departing from the spirit of the present invention. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to the described arrangement, or the position of existing elements may be modified, without changing the basic form or spirit of the invention.

A radar sensor arrangement is presented in FIG. 13H as a further embodiment of the present invention. The arrangement in FIG. 13H utilizes the concepts of IF modulation of the local oscillator signal as described in FIG. 13F combined with a transmit antenna selection switching element 501, illustrating that the use of solely switched spatially separated transmission antennas can be used to create spatially separated received signals. The arrangement in FIG. 13H is similar to the arrangement in FIG. 13F, except for the removal of transmit gating switch 75, the removal of receive selection switch 12, and the addition of transmit selection switch 501. The same components are denoted by the same reference numerals, and will not be explained again. In this arrangement, the transmit selection switch 501 directs the transmission signal to one of a plurality of spatially separated transmit antennas 101a, 101b. A signal TX_SEL is utilized to select which transmit antenna 101a, 101b the transmission signal is directed to. A receive antenna 121 directs a received signal to down-conversion circuitry. Through the use an IF modulation frequency and two stage down-conversion, the noise associated with the down-conversion process can be improved. In addition, even though only a single receiver channel is shown, a plurality of receiver channels can be utilized which can improve the SNR of the sensor.

The block diagram shown in FIG. 13H can be modified according to aspects of the present invention. One example of such a modification, not meant as a limitation, can be for the radar sensor architecture to replace the selection switch 501 with a plurality of switched amplifiers and signal combiners, utilizing the gain/loss of the switched amplifiers to realize an antenna selection and routing function. Another example of such a modification, not meant as a limitation, can be for the radar sensor architecture to use remote signal processing, remote analog-to-digital (A/D) conversion, or shared processing and/or shared A/D conversion. A further example of such a modification, not meant as a limitation, can be for the radar sensor architecture to share an RX antenna with the TX antenna function, or to utilize a plurality of switched RX antennas in combination with the switched TX antennas to synthesize a receive antenna array. Another example of such a modification, not meant as a limitation, can be for the radar sensor architecture to use an A/D converter to sample the intermediate frequency signal after the filter 39 and perform the second down-conversion digitally. Mixers 55, 85, 86 can be implemented by, but are not limited to, mixers, multipliers, or switches without changing the basic functionality of the arrangement. Filter 39 can be implemented by, but is not limited to, a band-pass filter or a low-pass filter. Filters 35, 36 can be implemented by, but are not limited to, low-pass filters. Local oscillator modulator 96 can be implemented by, but is not limited to, a switch, modulator, or bi-phase modulator. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to the described arrangement, or the position of existing elements may be modified, without changing the basic form or spirit of the invention.

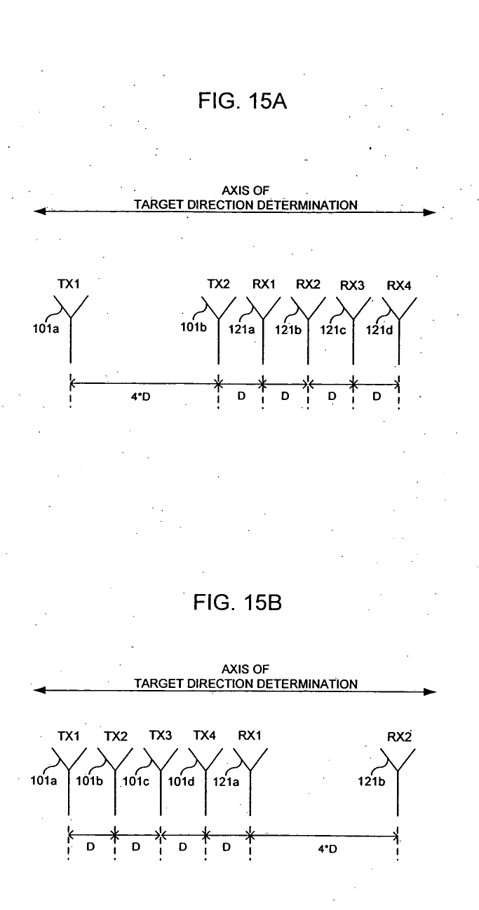

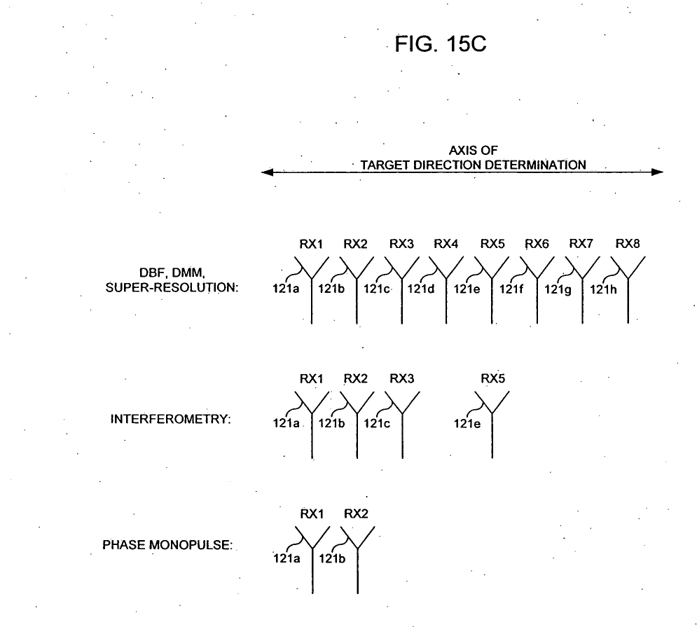

A radar sensor arrangement is presented in FIG. 14A as a yet further embodiment of the present invention. The arrangement in FIG. 14A is similar to the arrangement in FIG. 11, except for the addition of transmit antenna selection switch 501. The same components are denoted by the same reference numerals, and will not be explained again. In this configuration, the transmit signal is routed to one of k transmit antennas 101a, 101b, where k is an integer greater than or equal to 2, by way of a transmit antenna selection switch 501 controlled by a signal designated as TX_SEL. Each transmit antenna 101a, 101b are arrayed and spatially separated from each other in each axis in which target angular direction is to be determined. The reflected radar signal from a target is received by n receiver antennas 121, 171, 151, 141, where m is an integer greater than or equal to 2, and n is an integer greater than or equal to 4, which are arrayed and spatially separated from each other in each axis in which target angular direction is to be determined. Receive antenna selection switch 14 is used to selectively connect one receiver antenna at a time from one group of receiver antennas with one receiver/down-converter for the radar sensor in a sequential manner controlled by a signal designated as RX_SEL_A. Receive antenna selection switch 16 is used to selectively connect one receiver antenna at a time from a second group of receiver antennas with a second receiver/down-converter for the radar sensor in a sequential manner controlled by a signal designated as RX_SEL_B. Through selection of various combinations of transmit and receive antenna pairs, a receive antenna array is synthesized with the number of elements and spacing of elements based upon the number of unique transmit and receive pairs selected and the physical spacing between the elements of these pairs. As an example, not meant in any way as a limitation, let k=2 and n=4 for the arrangement in FIG. 14A, and let the physical transmit and receive antenna elements be spaced in the axis of target direction determination as illustrated in FIG. 15A. Let transmit antenna TX 1 be selected and receive antennas RX 1 and RX 3 be selected simultaneously. During the radar dwell time let the down-converted signals be digitized and stored for the two receive channels corresponding to these transmit and receive selection settings. Then let the receive elements RX 2 and RX 4 be selected for the next radar dwell time during which the down-converted signals be digitized and stored for the two receive channels corresponding to these transmit and receive selection settings. Repeat the above receive antenna selection settings for the next two radar dwell times but with the transmit antenna TX 2 selected. When completed, digitized down-converted signals corresponding to 8 combinations of transmit and receive antenna selections will be stored and can be used as part of the spatially separated signals processing methods previously described. The 8 combinations of transmit and receive antenna selections synthesized a receive array of 8 elements with each element having a center-to-center spacing of D. Similarly, the physical transmit and receive antenna elements can also be spaced in the axis of target direction determination as illustrated in FIG. 15B according to aspects of the present invention. In addition, the element to element spacing illustrated in FIGS. 15A and 15B is meant as an example and not a limitation, as other spacing and/or non-equal spacing can be utilized for advantage without departing from the spirit of the present invention. Furthermore, through the use of a plurality of receiver antenna groups and receiver selection switches, and parallel receiver/down-converters, the signal-to-noise-ratio (SNR) of the detected target returns can be improved in comparison with using only one receiver/down-converter. This can be important for automotive short-range radar (SRR) sensor collision warning or collision avoidance applications where a fast update rate of a target threat list and high target SNR are typically simultaneously required.

The block diagram shown in FIG. 14A can be modified according to aspects of the present invention. One example of such a modification, not meant as a limitation, can be for the radar sensor architecture to have more than two receiver/down-converter channels and more than two receiver antenna selection switches, or to have only one receiver/down-converter channel and one receiver antenna selection switch. Another example of such a modification, not meant as a limitation, can be for the radar sensor architecture to replace one or all of the selection switches 501, 502, 503 with a plurality of switched amplifiers and signal combiners/splitters, utilizing the gain/loss of the switched amplifiers to realize an antenna selection and routing function. A further example of such a modification, not meant as a limitation, can be to replace mixers 55, 56 with I/Q complex mixers for complex signal down-conversion and to modify the block diagram accordingly. Another example of such a modification, not meant as a limitation, can be for the radar sensor architecture to use remote signal processing, remote analog-to-digital (A/D) conversion, or shared processing and/or shared A/D conversion. A further example of such a modification, not meant as a limitation, can be for the radar sensor architecture to include T/R modulation circuitry and/or IF modulation circuitry as previously described in other radar sensor arrangements. Mixers 55, 56 can be implemented by, but are not limited to, mixers, multipliers, or switches without changing the basic functionality of the arrangement. Filters 45, 46 can be implemented by, but are not limited to, low-pass filters or band-pass filters. Signal splitters 27, can be implemented by, but are not limited to, Wilkinson power dividers, passive splitter, active splitter, or microwave coupler. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to the described arrangement, or the position of existing elements may be modified, without changing the basic form or spirit of the invention.

A radar sensor arrangement is presented in FIG. 14B as another embodiment of the present invention. The arrangement in FIG. 14B is similar to the arrangement in FIG. 13B, except for the addition of transmit antenna selection switch 501. The same components are denoted by the same reference numerals, and will not be explained again. In this arrangement, k transmit antennas 101a, 101b are connected to transmit antenna selection switch 501, where k is an integer greater than or equal to 2. The transmit antenna selection switch 501 is controlled by control signal TX_SEL, thus providing the transmit antenna selection functionality. The use of multiple spatially separated transmit and receive antenna locations gives the ability to synthesize a spatially separated receive antenna array compatible with spatially separated signals processing. In addition, through the use of T/R switching and intermediate frequency two stage down-conversion, signal dynamic range can be improved and the impact of the transmit VCO phase noise on the SNR of received signals can be reduced. Furthermore, through the use of a plurality of receiver antenna groups and receiver selection switches, and parallel receiver/down-converters, the signal-to-noise-ratio (SNR) of the detected target returns can be improved in comparison with using only one receiver/down-converter. This can be important for automotive short-range radar (SRR) sensor collision warning or collision avoidance applications where a fast update rate of a target threat list and high target SNR are typically simultaneously required.

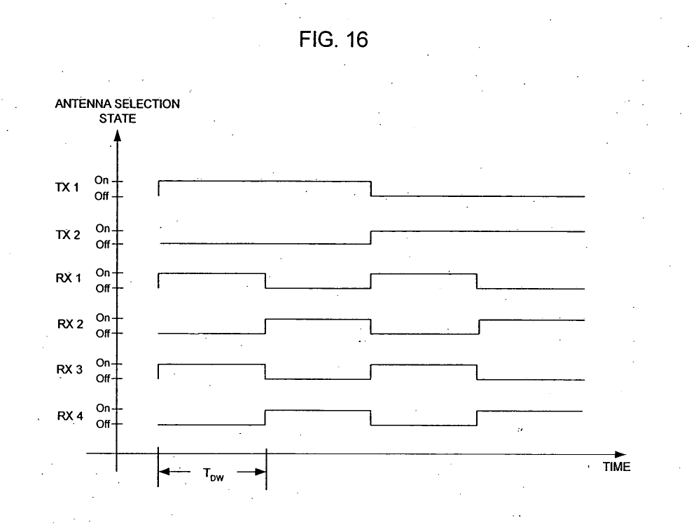

An example of transmit and receive series selection amplifier timing for the arrangement in FIG. 14B with k=2 and n=4 is illustrated in FIG. 16. This diagram shown is for illustration purposes and is not meant as a limitation. In this example, during the period of time when transmit antenna TX 1 is selected, receive antennas RX 1 and RX 3 are selected. After the radar dwell time T_{DW} is completed, receive antennas RX 1 and RX 3 are de-selected and receive antennas RX 2 and RX 4 are selected, while transmit antenna TX 1 remains selected. After the next radar dwell time is completed, the transmit antenna TX 1 is de-selected and the transmit antenna TX 2 is selected, antennas RX 1 and RX 3 are de-selected and receive antennas RX 1 and RX 3 are selected. After the next radar dwell time is completed, receive antennas RX 1 and RX 3 are de-selected and receive antennas RX 2 and RX 4 selected, while transmit antenna TX 2 remains selected. Thus after four radar dwell times, signals corresponding to eight different transmit/receive antenna combinations are down-converted and can be used for spatially separated signals processing on a synthesized receive antenna array of eight elements. In addition, the order of switching of transmit and receive antennas can be transposed such that for each selection of a receiver antenna RX n, the transmit antennas TX 1 and then TX 2 are sequentially selected and de-selected before RX n is deselected and Rx n+1 is selected.

The block diagram shown in FIG. 14B can be modified according to aspects of the present invention. One example is to remove transmit switch 75 and/or receiver switches 15 and 15a. Another example of such a modification, not meant as a limitation, can be for the radar sensor architecture to include more than two receive antenna selection switches and receiver/down-converter channels, such as, but not limited to, 4, 6, or 8 antenna selection switches and receiver/down-converter channels. A further example of such a modification, not meant as a limitation, can be for the radar sensor architecture to replace the selection switches 501, 14, 16 with a plurality of switched amplifiers and signal combiners/splitters, utilizing the gain/loss of the switched amplifiers to realize an antenna selection and routing function. A yet further example of such a modification, not meant as a limitation, can be for the radar sensor architecture to share an RX antenna with the TX antenna function. Another example of such a modification, not meant as a limitation, can be for the radar sensor architecture to use remote signal processing, remote analog-to-digital (A/D) conversion, or shared processing and/or shared A/D conversion. A further example of such a modification, not meant as a limitation, can be for the radar sensor architecture to use an A/D converter to sample the intermediate frequency signal after the filters 39, 39a and perform the second down-conversion digitally. Mixers 55, 55a can be implemented by, but are not limited to, mixers, multipliers, or switches without changing the basic functionality of the arrangement. Filters 39, 39a can be implemented by, but are not limited to, band-pass filters. Filters 35, 36, 35a, 36a can be implemented by, but are not limited to, low-pass filters. Receiver gating switches 15, 15a can be implemented by, but are not limited to, switches or modulators. The receiver gating switch can also be implemented by switching on and off a low noise amplifier (LNA) in place of receiver gating switches 15, 15a, creating signal isolation from the LNA's input to its output during the off state without departing from the present invention. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to the described arrangement, or the position of existing elements may be modified, without changing the basic form or spirit of the invention.

A radar sensor arrangement is presented in FIG. 14C as a further embodiment of the present invention. The arrangement in FIG. 14C is similar to the arrangement in FIG. 13G, except for the addition of transmit antenna selection switch 501 and the removal of transmit gating switch 75. The same components are denoted by the same reference numerals, and will not be explained again. In this arrangement, the transmit selection switch 501 directs the transmission signal to one of a plurality of spatially separated transmit antennas 101a, 101b. A signal TX_SEL is utilized to select which transmit antenna 101a, 101b the transmission signal is directed to. Through the use of a plurality of switched, spatially separated transmit and receive antennas, a receive array of spatially separated antennas can be synthesized using fewer physical antenna elements, saving size and cost of the radar sensor. In addition, through the use an IF modulation frequency and two stage down-conversion, the noise associated with the down-conversion process can be improved.

The block diagram shown in FIG. 14C can be modified according to aspects of the present invention. One example of such a modification, not meant as a limitation, can be for the radar sensor architecture to replace the selection switch 501 with a plurality of switched amplifiers and signal combiners, utilizing the gain/loss of the switched amplifiers to realize an antenna selection and routing function. Another example of such a modification, not meant as a limitation, can be for the radar sensor architecture to have only one receive selection switch 14, and only one receiver/down-conversion channel. A further example of such a modification, not meant as a limitation, can be for the radar sensor architecture to use remote signal processing, remote analog-to-digital (A/D) conversion, or shared processing and/or shared A/D conversion. A yet further example of such a modification, not meant as a limitation, can be for the radar sensor architecture to share an RX antenna with the TX antenna function. Another example of such a modification, not meant as a limitation, can be for the radar sensor architecture to use an A/D converter to sample the intermediate frequency signal after the filters 39, 39a and perform the second down-conversion digitally. Mixers 55, 55a can be implemented by, but are not limited to, mixers, multipliers, or switches without changing the basic functionality of the arrangement. Filters 39, 39a can be implemented by, but are not limited to, band-pass filters or low-pass filters. Filters 35, 36, 35a, 36a can be implemented by, but are not limited to, low-pass filters. Local oscillator modulator 96 can be implemented by, but is not limited to, a switch, modulator, or bi-phase modulator. Filters 39, 39a can also be removed from the arrangement without departing from the spirit of the present invention. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to the described arrangement, or the position of existing elements may be modified, without changing the basic form or spirit of the invention.

FIG. 15C illustrates that the use of different subsets of antennas of a set of spatially separated antennas can enable the implementation of different target direction processing algorithms for advantage. For example, the selection of two antennas enables the utilization of the phase monopulse direction finding method. Although adjacent antennas are illustrated for the phase monopulse method, non-adjacent pairs of antennas may be used as well. The use of a set of 3 or more antennas enables the implementation of an interferometry target detection algorithm enabling more precise target direction determination. Digital beam-forming (DBF) direction finding methods, as well as digital multi-beam monopulse (DMM) and super-resolution methods typically will process a greater number of antennas and therefore more processing is required. In addition, different antenna regions may use different algorithms for advantage or a detection region may switch algorithms for advantage.

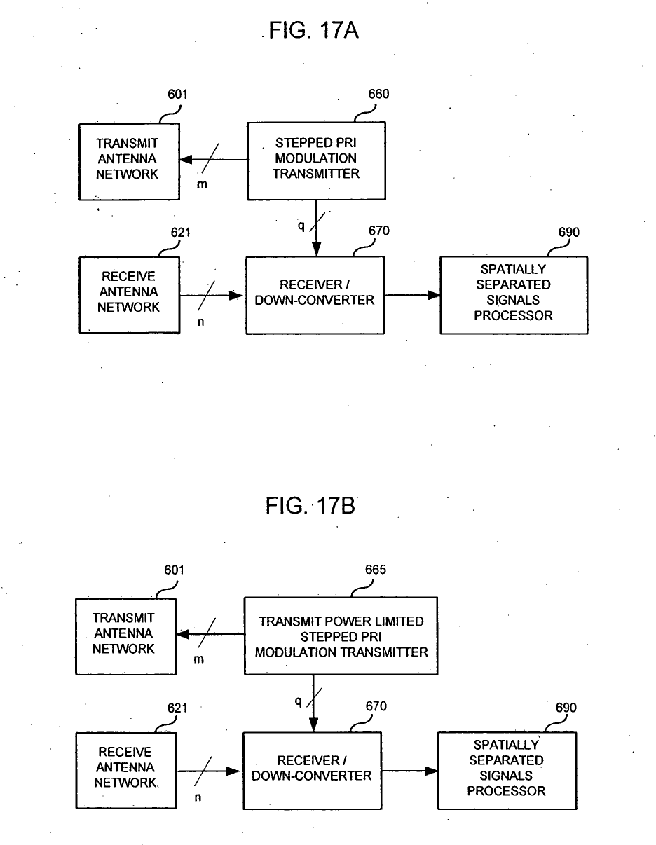

The previously described methods and architectures can be adapted for use with stepped pulse repetition interval (PRI) waveforms and methods according to aspects of the present invention. As an example, a radar sensor arrangement is presented in FIG. 17A as one embodiment of aspects of the present invention. The arrangement in FIG. 17A is similar to the arrangement in FIG. 2A, except that the Stepped Frequency Modulation Transmitter 650 has been replaced by a Stepped PRI Modulation Transmitter 660. The same components are denoted by the same reference numerals, and will not be explained again. In this arrangement, the Stepped PRI Modulation Transmitter 660 outputs m signals to a Transmit Antenna Network 601 for electromagnetic emission, where m is an integer greater than or equal to 1. A typical frequency of the output signal emitted from the Transmit Antenna Network 601 can be within, but is not limited to, the frequency range of 22 GHz-29 GHz or 76 GHz-81 GHz. The radar sensor's total occupied transmit spectral bandwidth is dependent on the radar frequency modulation bandwidth, and can be ultra-wideband (UWB) to achieve increased range resolution for some automotive applications. The reflected signal from a target will be received by Receive Antenna Network 621, which will output n signals to a Receiver/Down-converter 670, where n is an integer greater than or equal to 1. The Receiver/Down-converter 670 also accepts q signals from the Stepped PRI Modulation Transmitter 660, where q is an integer greater than or equal to 1, and outputs one or a plurality of signals each comprising at least one of the frequency or phase difference between components of the emitted signal and corresponding received reflected signal from a target as an input to a Spatially Separated Signals Processor 690. The Spatially Separated Signals Processor 690 is used to determine at least the angular direction of one or a plurality of target returns based upon processing of the down-converted difference signals corresponding to a plurality of transmit and/or receive antenna locations which are spatially separated in the axis in which the angular direction of target returns is to be determined. The Receiver/Down-converter can utilize one or a plurality of individual down-conversion operations in generating the output difference signals. The Stepped Frequency Modulation Transmitter 650 can include, but is not limited to, generation of one or a plurality of linearly stepped frequency signals, intermediate frequency signal generation, local oscillator signal generation, transmit and/or receive gating signal generation, or transmit pulsing signal generation. The Transmit Antenna Network 601 can include, but is not limited to, a single antenna, a plurality of spatially separated antennas, or one or a plurality of groups of spatially separated antennas with one or a plurality of antennas simultaneously selected for emission of one or a plurality of signals. The Receive Antenna Network 621 can include, but is not limited to, a single antenna, a plurality of spatially separated antennas, or one or a plurality of groups of spatially separated antennas with one or a plurality of antennas simultaneously selected for reception of one or a plurality of signals.

A radar sensor arrangement is presented in FIG. 17B as another embodiment of aspects of the present invention. The arrangement in FIG. 17B is similar to the arrangement in FIG. 17A, except that the Stepped PRI Modulation Transmitter 660 has been replaced by a Transmit Power Limited Stepped PRI Modulation Transmitter 665. The same components are denoted by the same reference numerals, and will not be explained again. The Transmit Power Limited Stepped PRI Modulation Transmitter 665 is similar to the Stepped PRI Modulation Transmitter 660 except for the addition of circuitry to limit and/or control the output transmit power. This circuitry is important for some short-range sensor frequency bands of operation where strict emission power limits are imposed with very low allowed transmit power density levels. Under these conditions, having power control circuitry that ensures the transmit power is close to, but below, the legislated limits allows legislative compliance and preserves signal to noise ratio (SNR), which is important for many applications such as pre-crash detection.

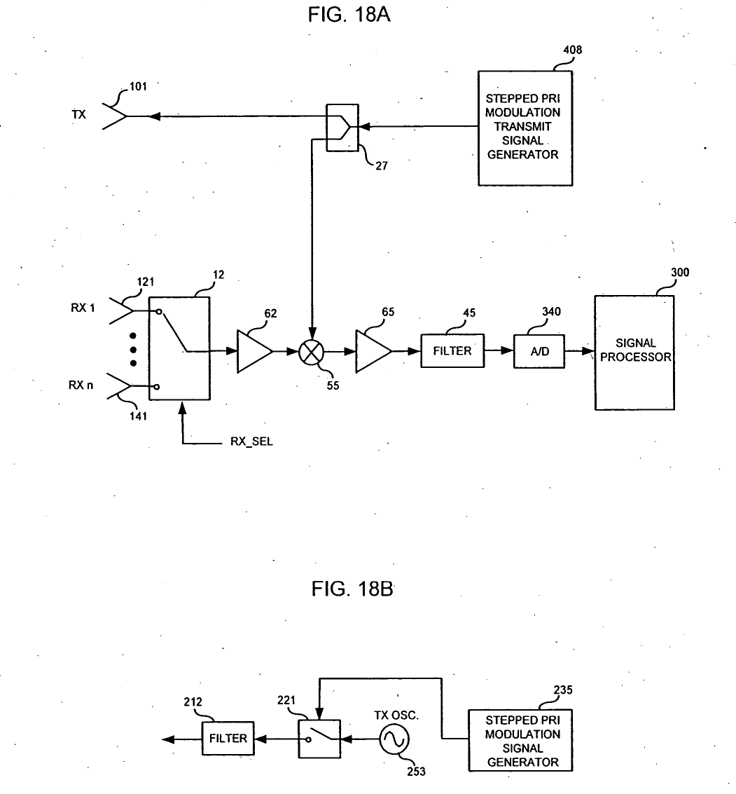

A radar sensor arrangement is presented in FIG. 18A as a further embodiment of aspects of the present invention. The arrangement in FIG. 18A is similar to the arrangement in FIG. 7, except that the Stepped Frequency Transmit Signal Generator 405 has been replaced by a Stepped PRI Modulation Transmit Signal Generator 408. The same components are denoted by the same reference numerals, and will not be explained again. In this arrangement, a stepped PRI modulated transmit signal generated by the Stepped PRI Modulation Transmit Signal Generator 408 is split by a signal splitter 27, where one portion of the signal proceeds to an antenna means 101 for transmission of the signal towards a target. A typical frequency of the output signal from the Stepped PRI Modulation Transmit Signal Generator 408 can be within, but is not limited to, the frequency range of 22 GHz-29 GHz or 76 GHz-81 GHz. The radar sensor's total occupied transmit spectral bandwidth is dependent on the radar frequency modulation bandwidth, and can be ultra-wideband (UWB) to achieve increased range resolution for some automotive applications. The reflected signal from a target will be received by an array of n receiver antennas 121, 141, designated by RX 1, RX n, where n is an integer greater than or equal to 2. The n receiver antennas are arrayed and spatially separated from each other in each axis in which target angular direction is to be determined. A selection switch 12 is used to selectively connect one receiver antenna at a time with the receiver/down-converter for the radar sensor in a sequential manner. The selection switch is controlled by a signal designated as RX_SEL. The receiver/down-converter for the radar sensor consists of a low noise amplifier 62 where the received signal is amplified prior to being input to down-converting mixer 55, where the signal is mixed with one output signal from signal splitter 27, and the resulting signal is amplified by amplifier 65 and filtered by filter 45. After filtering by filter 45, the resulting signal is then digitized by analog-to-digital converter 340 and input to a signal processor 300 for signal processing. During the dwell time for each receiver antenna in the receiver array, the signal segment corresponding to that antenna's spatial position is digitized and stored for use as part of a spatially separated signals processing method.

One embodiment of Stepped PRI Modulation Transmit Signal Generator 408 is shown in FIG. 18B. In this configuration, a Stepped PRI Modulation Signal Generator 235 controls the pulse repetition interval (PRI) of a transmit gating switch 221. The transmit gating switch 221 pulses the output of a transmit oscillator 253, and outputs the pulse modulated signal to a filter 212. The transmit gating switch 221 can be implemented by, but is not limited to, a switch or a bi-phase modulator. The filter 212 can be implemented by, but is not limited to, a low-pass, a high-pass, or a band-pass filter. One purpose for the filter 212 can be, but is not limited to, the passing of only a single-sideband of the modulation for transmission. Another purpose for the filter 212 can be, but is not limited to, the limiting of the spectrum of the transmitted signal.

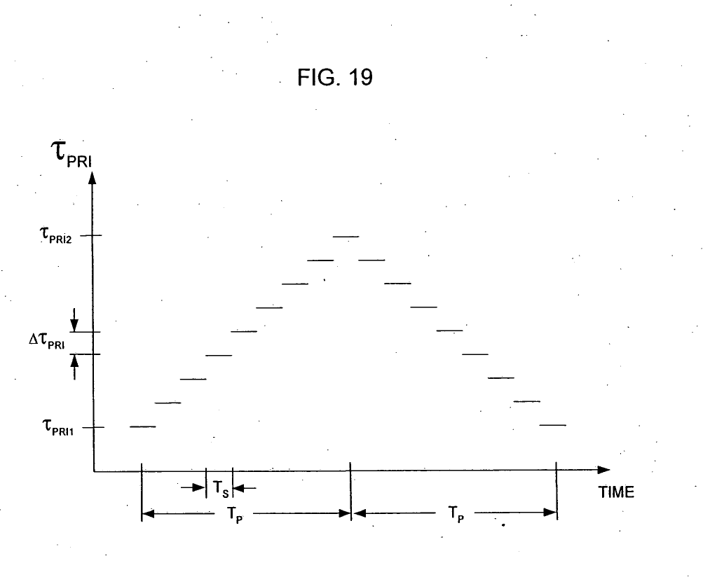

FIG. 19 illustrates a stepped PRI modulation waveform for use in the stepped PRI modulation signal generator 235 according to aspects of the present invention. This waveform shows a linearly stepped PRI pattern during a time period T_{P}. This waveform shown is an example of linearly stepped PRI modulation, and is not meant as a limitation. The waveform can also comprise, but is not limited to, a repeating pattern of linearly increasing PRI steps, a repeating pattern of linearly decreasing PRI steps, alternating periods of linearly increasing and decreasing PRI step patterns, or a plurality of intertwined linearly stepped PRI waveforms. Also, periods where the stepped PRI modulation pattern is stopped may be inserted into the abovementioned patterns.

Using the type of PRI modulation waveform described in FIG. 19, target information may be calculated from the down-converted signals in the following way. Peaks in the down-converted signal spectrum represent target returns. The frequency of the target peaks is proportional to target range and is used to calculate target range. As an example, not meant in any way as a limitation, let the radar arrangement of FIG. 18 transmit a single sideband, upper sideband radar signal and utilize a linearly increasing PRI step sequence and linearly decreasing PRI step sequence as shown in FIG. 19. Let the digitized down-converted signals be measured during each coherent measurement interval T_{P}, which for this example also corresponds to the PRI increasing step sequence period and decreasing step sequence period. Under these conditions, target range can be calculated by the following equation:

$$R = \frac{c \cdot {T}_{S} \cdot {Δτ}_{PRI}}{4} \cdot ( {f}_{PU} + {f}_{PD} ) \qquad ( 9 )$$

where R is the calculated target range, c is the speed of light in a vacuum, T_{S} is dwell time of each PRI step, Δτ_{PRI} is the difference between adjacent PRI step values in the linear step sequence, and f_{PU} and f_{PD} are the beat frequencies in the digitized down-converted signal corresponding to measurements during the PRI increasing sequence and PRI decreasing sequence periods T_{P} respectively.

The Doppler frequency shift of the target frequency peaks is used to calculate target velocity. As an example, not meant in any way as a limitation, let the radar arrangement of FIG. 18 transmit a single sideband, upper sideband radar signal and utilize a linearly increasing PRI step sequence and linearly decreasing PRI step sequence as shown in FIG. 14C. Let the digitized down-converted signals be measured during each coherent measurement interval T_{P}, which for this example also corresponds to the PRI increasing step sequence period and decreasing step sequence period. Under these conditions, target relative velocity can be calculated by the following equation:

$$V = \frac{c}{4 {f}_{C} + 2 / {τ}_{PRI 1} + 2 / {τ}_{PRI 2}} \cdot ( {f}_{PU} - {f}_{PD} ) \qquad ( 10 )$$

where V is the calculated target relative velocity defined as positive for an approaching target, c is the speed of light in a vacuum, f_{C} is the frequency of the transmit oscillator 253, τ_{PR11} and τ_{PRI2} are the minimum and maximum PRI values in the linear sequence during a coherent measurement period T_{P}, and f_{PU} and f_{PD} are the beat frequencies in the digitized down-converted signal corresponding to the measurements during the PRI up step sequence and down step sequence periods T_{P} respectively.

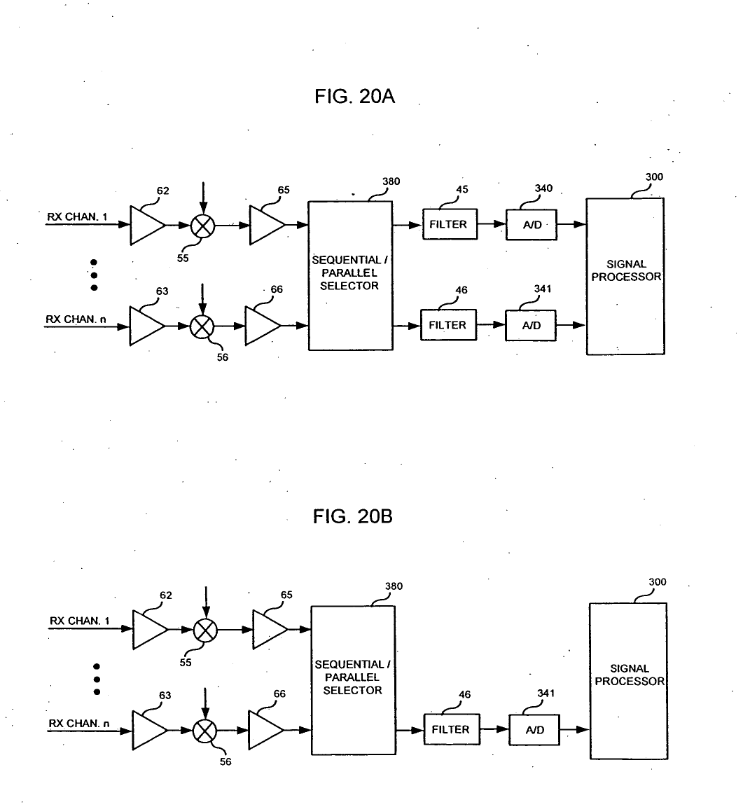

The previously described methods and architectures can be adapted for use with an analog signal selector prior to A/D conversion such that A/D conversion of the down-converted signals can be fully parallel, fully sequential, or a combination of sequential and parallel, according to aspects of the present invention. As an example, a radar sensor arrangement is presented in FIG. 20A as one embodiment of aspects of the present invention. The arrangement in FIG. 20A is similar to the arrangement in FIG. 14A, except that an analog signal sequential/parallel selector 380 is utilized after down-conversion prior to an A/D conversion operation. The analog signal sequential/parallel selector 380 is used to select which analog down-converted signals are routed to which A/D converted at a certain time. A fully parallel mode of operation can select each down-converted signal to route to each A/D converter simultaneously in parallel, as illustrated in FIG. 20A. A fully serial mode of operation can select each down-converted signal to route a single A/D converter sequentially in time, as illustrated in FIG. 20B. Additionally, other modes of operation can combine sequential and parallel signal routing to a plurality of A/D converters. Through the use of an analog signal sequential/parallel selector 380, a single radar sensor arrangement can adapt to a number of application requirements, trading off cost of A/D converters and associated pre-filtering with sensor performance such as SNR.

The concepts described in the preceding figures can be further modified according to aspects of the present invention. One such modification is that in addition to the stepped frequency modulation of the transmit signal, the pulse repetition interval (PRI) of the transmit signal or the T/R modulation frequency can be varied, modulated, or gated for advantage.

The preceding concepts, methods, and architectural elements described are meant as illustrative examples of aspects of the present invention, not as a limitation, as many additional combinations can be used to create spatially separated signals compatible with the stepped waveforms and methods presented. Different combinations of these concepts, methods, and architectural elements than those described in the preceding figures can be utilized by one of ordinary skill in the art without departing from the spirit of the present invention. For example, not meant as any limitation, any antenna method whereby spatially separated signals are generated for receiver processing may be utilized in combination with any of the preceding illustrated methods. In addition, the methods illustrated with single down-conversion can be utilized with additional down-conversion circuitry such as, but not limited to, the two-stage down-conversion methods illustrated. Furthermore each of the transmitters shown may or may not include transmit power limited circuitry. Additionally, transmit signal pulsing may be used in combination with any of the preceding illustrated methods. Also, transmitter and/or receiver gating may be used in combination with any of the preceding illustrated methods. Furthermore, a plurality of transmit and/or receive detection zones may be utilized. In addition, different target direction determination methods may be applied to different detection zones or within the same detection zone at different times. Furthermore, any of the methods and arrangements illustrated can be used with radar signals having bandwidths which are wideband (WB), ultra wideband (UWB), or precision ultra-wideband (PUWB) as part of the present invention.

Combinations of the architectural elements, waveforms, and processing methods presented herein can be utilized in a radar sensor through software-adaptable configuration and operation according to aspects of the present invention. One benefit of software-adaptable hardware and methods can be to share the radar sensor operation across multiple applications. Another benefit of software-adaptable hardware and methods can be to adapt the radar sensor operation or application time sharing based upon detected target characteristics or target threat level to maximize effectiveness of the sensor for safety or driver aid applications.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A radar method for motor vehicles for determining characteristics of a target, comprising:
modulating the frequency of a carrier signal to generate a first transmission signal with a first bandwidth and first power level;
transmitting of said first transmission signal towards a target during a first transmission period;
receiving a reflected portion of said first transmitted signal from said target by a plurality of spatially separated antennas to output a plurality of signals representing said reflected portion;
downconverting said plurality of signals by generating difference signals of said plurality of signals and a signal derived from said first transmission signal;
modulating the frequency of a carrier signal to generate a second transmission signal with a second bandwidth and second power level;
transmitting of said second transmission signal towards a target during a second transmission period;
receiving a reflected portion of said second transmitted signal from said target by a plurality of spatially separated antennas to output a plurality of signals representing said reflected portion;
determining at least one of a target range and a target relative velocity based on at least one of the frequency and phase components of said difference signals acquired during at least one of said first transmission period and said second transmission period; and,
determining target direction based on a phase difference between components of at least two of said difference signals acquired during at least one of said first transmission period and said second transmission period.

2. The method of claim 1, wherein determining at least one of said target range and said target relative velocity comprises performing a Fourier transformation on said difference signals and evaluating at least one of the frequency and phase of a peak occurring in said Fourier transformation to determine at least one of said frequency and phase components of said difference signals.

3. The method of claim 1, wherein determining target direction comprises using a phase difference between peaks occurring between said Fourier transformations of at least two difference signals.

4. The method of claim 1, wherein said first transmission period and said second transmission period are interleaved in time sequence.

5. The method of claim 1, wherein determining target direction comprises utilizing phase monopulse signal processing.

6. The method of claim 1, wherein determining target direction comprises using interferometry.

7. The method of claim 1, wherein determining target direction comprises using digital beam-forming.

8. The method of claim 1, wherein determining target direction comprises using a super-resolution algorithm.

9. The method of claim 1, wherein determining target direction comprises utilizing digital multi-zone monopulse signal processing.

10. The method of claim 1, wherein determining target direction comprises utilizing spatial FFT signal processing.

11. The method of claim 1, wherein modulating the frequency of a carrier signal comprises one or more linear frequency stepped intervals with respect to time.

12. The method of claim 1, wherein modulating the frequency of a carrier signal comprises one or more linear frequency modulated intervals with respect to time.

13. The method of claim 1, further comprising performing a second downconversion of said difference signals.

14. The method of claim 1, wherein said first power level and said second power level are different.

15. The method of claim 1, wherein said first bandwidth and said second bandwidth are different.

16. The method of claim 1, wherein said antenna network selects between a plurality of detection zones.

17. The method of claim 16, wherein at least one of said first and second power levels and said first and second bandwidths are different between at least two of said detection zones.

18. The method of claim 1, wherein said antenna network has a total coverage area of greater than 90 degrees.

19. A radar method for motor vehicles for determining characteristics of a target, comprising:
modulating the frequency of a carrier signal by a sequence of frequency steps to generate a transmission signal during a coherent measurement time duration, wherein said sequence of frequency steps comprises two time-interleaved, identical frequency-stepped sequences shifted in time with respect to each other;
transmitting of said transmission signal towards a target;
receiving a reflected portion of said transmitted signal from said target by a plurality of spatially separated antennas to output a plurality of signals representing said reflected portion;
downconverting said plurality of signals and generating difference signals of said plurality of signals and a signal derived from said transmission signal;
determining at least one of a target range and a target relative velocity based on at least one of the frequency and phase components of said difference signals; and
determining target direction based on processing the phase difference between components of at least two of said difference signals.

20. The method of claim 19, wherein determining at least one of said target range and said target relative velocity comprises performing a Fourier transformation on said difference signals and evaluating at least one of the frequency and phase of a peak occurring in said Fourier transformation to determine at least one of said frequency and phase components of said difference signals.

21. The method of claim 19, wherein determining target direction comprises using a phase difference between peaks occurring between said Fourier transformations of at least two difference signals.

22. The method of claim 19, wherein said frequency stepped sequences are linearly stepped with respect to time.

23. The method of claim 19, wherein determining target direction comprises using interferometry.

24. The method of claim 19, wherein determining target direction comprises using digital beam-forming.

25. The method of claim 19, wherein determining target direction comprises using a super-resolution algorithm.

26. The method of claim 19, wherein determining target direction comprises using digital multi-zone monopulse signal processing.

27. The method of claim 19, wherein determining target direction comprises using spatial FFT signal processing.

28. A radar method for motor vehicles for determining characteristics of a target, comprising:
modulating the frequency of a carrier signal to generate a transmission signal during a coherent measurement time duration;
transmitting of said transmission signal towards a target;
receiving a reflected portion of said transmitted signal from said target by a plurality of spatially separated antennas to output a plurality of signals representing said reflected portion;
downconverting said plurality of signals by generating difference signals of said plurality of signals and a signal derived from said transmission signal;
determining at least one of a target range and a target relative velocity based on at least one of the frequency and phase components of said difference signals;
determining target direction based on processing the phase difference between components of at least two of said difference signals; and
modifying the modulation of said carrier signal to generate a different transmission signal for each subsequent coherent measurement time duration.

29. A radar method for motor vehicles for determining characteristics of a target, comprising:
modulating the frequency of a carrier signal to generate a transmission signal during a coherent measurement time duration;
transmitting of said transmission signal towards a target;
receiving a reflected portion of said transmitted signal from said target by a plurality of spatially separated antennas to output a plurality of signals representing said reflected portion;
downconverting said plurality of signals by generating difference signals of said plurality of signals and a signal derived from said transmission signal, whereby said downconverting occurs simultaneously on at least two of said plurality of signals;
sequentially selecting at least two of said difference signals to be digitized in a time-interleaved manner;
determining at least one of a target range and a target relative velocity based on at least one of the frequency and phase components of said difference signals; and
determining target direction based on processing the phase difference between components of at least two of said difference signals.
